(19) United States
(12) Patent Application Publication
(10) Pub. No.: US 2014/0154555 A1
(43) Pub. Date: Jun. 5, 2014

(54) SECONDARY BATTERY-USE ACTIVE MATERIAL, SECONDARY BATTERY-USE ELECTRODE, SECONDARY BATTERY, BATTERY PACK, ELECTRIC VEHICLE, ELECTRIC POWER STORAGE SYSTEM, ELECTRIC POWER TOOL, AND ELECTRONIC APPARATUS

(71) Applicant: Sony Corporation, Tokyo (JP)

(72) Inventors: Kazuaki Endoh, Kanagawa (JP); Kazunari Motohashi, Kanagawa (JP); Hironobu Tsuji, Kanagawa (JP); Yosuke Hosoya, Fukushima (JP); Akinori Kita, Fukushima (JP); Masaki Misawa, Tochigi (JP); Hideki Nakai, Saitama (JP); Yosuke Murakami, Kanagawa (JP)

(73) Assignee: Sony Corporation, Tokyo (JP)

(21) Appl. No.: 14/091,786

(22) Filed: Nov. 27, 2013

(30) Foreign Application Priority Data
Dec. 5, 2012 (JP) 2012-266142

(51) Int. Cl. H01M 4/50; H01M 4/48; H01M 10/052

(52) U.S. Cl. CPC H01M 4/502; H01M 10/052; H01M 4/48
USPC 429/150; 429/223; 429/221

(57) ABSTRACT

A secondary battery includes: a cathode; an anode; and an electrolytic solution. The cathode includes a lithium-containing compound having an average composition represented by a following Formula (1), the lithium-containing compound includes a central section and a surface section, a molar ratio b1 of manganese (Mn) in the surface section is larger than a molar ratio b2 of Mn in the central section, a molar ratio 1+a1 of lithium (Li) in the surface section is smaller than a molar ratio 1+a2 of Li in the central section, and a ratio 1+a1/1+a2 between the molar ratio 1+a1 of Li in the surface section and the molar ratio 1+a2 of Li in the central section satisfies 0.5<1+a1/1+a2<1,

Li₁₊ₐ(Mn_{b}Co_{c}Ni_{1-b-c})₁₋ₐM_{d}O₂₋ₑ (1)

where M is one or more of aluminum, magnesium, zirconium, titanium, barium, boron, silicon, and iron; and a to e satisfy 0<a<0.25, 0.5≦b<0.7, 0≦c<1−b, 0≦d≦1, and 0≦e≦1.

### CROSS REFERENCES TO RELATED APPLICATIONS

The present application claims priority to Japanese Priority Patent Application JP 2012-266142 filed in the Japan Patent Office on Dec. 5, 2012, the entire content of which is hereby incorporated by reference.

### BACKGROUND

The present application relates to a secondary battery-use active material including a lithium-containing compound, to a secondary battery-use electrode and a secondary battery that use the secondary battery-use active material, and to a battery pack, an electric vehicle, an electric power storage system, an electric power tool, and an electronic apparatus that use the secondary battery.

In recent years, various electronic apparatuses such as a mobile phone and a personal digital assistant (PDA) have been widely used, and it has been demanded to further reduce the size and the weight of the electronic apparatuses and to achieve their long life. Accordingly, as an electric power source for the electronic apparatuses, a battery, in particular, a small and light-weight secondary battery capable of providing high energy density has been developed.

In these days, it has been considered to apply such a secondary battery to various other applications in addition to the foregoing electronic apparatuses. Examples of such other applications may include a battery pack attachably and detachably mounted on the electronic apparatuses or the like, an electric vehicle such as an electric automobile, an electric power storage system such as a home electric power server, and an electric power tool such as an electric drill.

Secondary batteries utilizing various charge-discharge principles to obtain a battery capacity have been proposed. In particular, a lithium secondary battery using lithium (Li) as an electrode reactant has attracted attention, since such a lithium secondary battery provides higher energy density than lead batteries, nickel-cadmium batteries, and the like.

The secondary battery includes a cathode, an anode, and an electrolytic solution. The cathode contains a cathode active material that inserts and extracts Li, and the anode contains an anode active material that inserts and extracts Li.

As the anode active material, in general, a carbon material such as graphite has been widely used. In contrast, in these days, electric power consumption has been increased due to multi-functionalized electronic apparatuses and the like. Accordingly, in order to achieve a higher capacity, using a high-capacity material such as silicon (Si) and tin (Sn) having a higher theoretical capacity than that of the carbon material has been considered.

Under such a technical background, various studies have been made on compositions, configurations, and the like of cathode active materials according to various purposes. Specifically, in order to improve charge-discharge cycle characteristics, a coating film made of a metal oxide such as magnesium oxide (MgO) is formed on the surface of a cathode containing a composite oxide (LiₓNi_{1-y}Co_{y}O_{z}) (for example, see Japanese Patent No. 3172388). In order to improve structural stability and thermal stability of a cathode active material, the surface of a composite oxide (LiA_{1-x-y}BₓC_{y}O₂: A represents Co or the like, B represents Ni or the like, and C represents Al or the like) is coated with a metal oxide such as an oxide of aluminum (Al) (for example, see Japanese Patent No. 3691279). In order to thermodynamically and mechanically stabilize a cathode active material, a material obtained by reacting a cation supply compound having a high affinity with respect to lithium with a lithium-transition-metal composite oxide is used (for example, see U.S. Pat. No. 7,364,793).

In order to improve a cycle life and an initial capacity, the surface of a spinel-type composite oxide (LiₐMn_{b}M_{c}O₄: M represents Mg or the like) is coated with a metal oxide such as an oxide of Al (for example, see Japanese Unexamined Patent Application Publication No. 2009-206047). In order to improve a battery capacity and charge-discharge cycle characteristics, an oxide containing Li and an element such as Ni is formed on the surface of a composite oxide (Li_{1+w}Co_{1-x-y}GaₓM_{y}O_{2-z}: M represents Mg or the like) (for example, see Japanese Unexamined Patent Application Publication No. 2007-335169). In order to improve capacity characteristics, life characteristics, and thermal stability, in a composite oxide including an inner bulk section (LiₐNi_{1-x-y-z}CoₓMn_{y}M_{z}O_{2-δ}X_{δ}: M represents Mg or the like, and X represents F or the like) and an outer bulk section (LiₐNi_{1-x-y-z}CoₓMn_{y}M_{z}O_{2-δ}X_{δ}: M represents Mg or the like, and X represents F or the like), the metal composition is continuously changed from the interface between the inner bulk section and the outer bulk section toward the surface of the composite oxide (for example, see Japanese Unexamined Patent Application Publication (Published Japanese Translation of PCT Application) No. 2009-525578).

In order to sufficiently utilize high capacity characteristics of an Si-based anode active material or an Sn-based anode active material, a lithium-rich composite oxide (a solid solution represented by Li₁₊ₓ(Mn_{α}Co_{β}Ni_{γ})₁₋ₓO₂.aLi_{4/3}Mn_{2/3}O₂) is used (for example, see Japanese Unexamined Patent Application Publication No. 2009-158415). In order to improve conservation characteristics and the like, a composite oxide (LiNi₁₋ₓMₓO₂: M represents an element capable of becoming a cation other than Ni and the like) in which the peak intensity ratio measured in X-ray diffraction analysis satisfies predetermined conditions is used (for example, see Japanese Unexamined Patent Application Publication No. H06-215800). In order to suppress elution of manganese (Mn) even after repeated charge and discharge at a high rate, solid solution particles formed of a lithium-transition-metal composite oxide (LiMO₂: M represents Mn or the like) and a lithium-manganese oxide (Li₂MnO₃) is used (for example, see Japanese Unexamined Patent Application Publication No. 2011-134670). In the solid solution particles, as a position is closer to the central section thereof, the concentration of Li₂MnO₃ is higher than the concentration of LiMO₂.

In order to improve cycle characteristics, a composite oxide containing Li, Ni, and Co, in which the Co concentration in a region in the vicinity of the surface thereof is higher than the Co concentration in the internal region thereof is used (for example, see Japanese Unexamined Patent Application Publication No. 2003-059489). In order to suppress increase of internal resistance, a lithium-containing composite oxide in which the Li concentration of the surface section of primary particles is lower than the Li concentration of the internal region thereof is used (for example, see Japanese Patent No. 4089526).

### SUMMARY

In the case where a high-capacity material is used as an anode active material, while a high battery capacity is obtained, the irreversible capacity at the time of the initial charge and discharge is increased, and therefore, a so-called capacity loss is increased. Therefore, it has been desired to suppress the capacity loss while advantages of the high capacity material are utilized.

It is desirable to provide a secondary battery-use active material, a secondary battery-use electrode, a secondary battery, a battery pack, an electric vehicle, an electric power storage system, an electric power tool, and an electronic apparatus that are capable of obtaining superior battery characteristics.

According to an embodiment of the present application, there is provided a secondary battery-use active material, the secondary battery-use active material including a lithium-containing compound, the lithium-containing compound having an average composition represented by a following Formula (1), in which the lithium-containing compound includes a central section and a surface section, a molar ratio b1 of Mn in the surface section is larger than a molar ratio b2 of Mn in the central section, a molar ratio 1+a1 of Li in the surface section is smaller than a molar ratio 1+a2 of Li in the central section, and a ratio 1+a1/1+a2 between the molar ratio 1+a1 of Li in the surface section and the molar ratio 1+a2 of Li in the central section satisfies 0.5<1+a1/1+a2<1,

Li₁₊ₐ(Mn_{b}Co_{c}Ni_{1-b-c})₁₋ₐM_{d}O₂₋ₑ (1)

where M is one or more of Al, Mg, Zr, Ti, Ba, B, Si, and Fe; and a to e satisfy 0<a<0.25, 0.5≦b<0.7, 0≦c<1−b, 0≦d≦1, and 0≦e≦1.

According to an embodiment of the present application, there is provided a secondary battery-use electrode, the secondary battery-use electrode including a lithium-containing compound, the lithium-containing compound having an average composition represented by a following Formula (1), in which the lithium-containing compound includes a central section and a surface section, a molar ratio b1 of Mn in the surface section is larger than a molar ratio b2 of Mn in the central section, a molar ratio 1+a1 of Li in the surface section is smaller than a molar ratio 1+a2 of Li in the central section, and a ratio 1+a1/1+a2 between the molar ratio 1+a1 of Li in the surface section and the molar ratio 1+a2 of Li in the central section satisfies 0.5<1+a1/1+a2<1,

Li₁₊ₐ(Mn_{b}Co_{c}Ni_{1-b-c})₁₋ₐM_{d}O₂₋ₑ (1)

where M is one or more of Al, Mg, Zr, Ti, Ba, B, Si, and Fe; and a to e satisfy 0<a<0.25, 0.5≦b<0.7, 0≦c<1−b, 0≦d≦1, and 0≦e≦1.

According to an embodiment of the present application, there is provided a secondary battery including a cathode; an anode; and an electrolytic solution, in which the cathode includes a lithium-containing compound, the lithium-containing compound having an average composition represented by a following Formula (1), the lithium-containing compound includes a central section and a surface section, a molar ratio b1 of manganese (Mn) in the surface section is larger than a molar ratio b2 of Mn in the central section, a molar ratio 1+a1 of lithium (Li) in the surface section is smaller than a molar ratio 1+a2 of Li in the central section, and a ratio 1+a1/1+a2 between the molar ratio 1+a1 of Li in the surface section and the molar ratio 1+a2 of Li in the central section satisfies 0.5<1+a1/1+a2<1,

Li₁₊ₐ(Mn_{b}Co_{c}Ni_{1-b-c})₁₋ₐM_{d}O₂₋ₑ (1)

where M is one or more of aluminum (Al), magnesium (Mg), zirconium (Zr), titanium (Ti), barium (Ba), boron (B), silicon (Si), and iron (Fe); and a to e satisfy 0<a<0.25, 0.5≦b<0.7, 0≦c<1−b, 0≦d≦1, and 0≦e≦1.

According to an embodiment of the present application, there is provided a battery pack including: a secondary battery; a control section configured to control operation of the secondary battery; and a switch section configured to switch the operation of the secondary battery according to an instruction of the control section, in which the secondary battery includes a cathode, an anode, and an electrolytic solution, the cathode includes a lithium-containing compound, the lithium-containing compound having an average composition represented by a following Formula (1), the lithium-containing compound includes a central section and a surface section, a molar ratio b1 of Mn in the surface section is larger than a molar ratio b2 of Mn in the central section, a molar ratio 1+a1 of Li in the surface section is smaller than a molar ratio 1+a2 of Li in the central section, and a ratio 1+a1/1+a2 between the molar ratio 1+a1 of Li in the surface section and the molar ratio 1+a2 of Li in the central section satisfies 0.5<1+a1/1+a2<1,

Li₁₊ₐ(Mn_{b}Co_{c}Ni_{1-b-c})₁₋ₐM_{d}O₂₋ₑ (1)

where M is one or more of Al, Mg, Zr, Ti, Ba, B, Si, and Fe; and a to e satisfy 0<a<0.25, 0.5≦b<0.7, 0≦c<1−b, 0≦d≦1, and 0≦e≦1.

According to an embodiment of the present application, there is provided an electric vehicle including a secondary battery; a conversion section configured to convert electric power supplied from the secondary battery into drive power; a drive section configured to operate according to the drive power; and a control section configured to control operation of the secondary battery, in which the secondary battery includes a cathode, an anode, and an electrolytic solution, the cathode includes a lithium-containing compound, the lithium-containing compound having an average composition represented by a following Formula (1), the lithium-containing compound includes a central section and a surface section, a molar ratio b1 of Mn in the surface section is larger than a molar ratio b2 of Mn in the central section, a molar ratio 1+a1 of Li in the surface section is smaller than a molar ratio 1+a2 of Li in the central section, and a ratio 1+a1/1+a2 between the molar ratio 1+a1 of Li in the surface section and the molar ratio 1+a2 of Li in the central section satisfies 0.5<1+a1/1+a2<1,

Li₁₊ₐ(Mn_{b}Co_{c}Ni_{1-b-c})₁₋ₐM_{d}O₂₋ₑ (1)

where M is one or more of Al, Mg, Zr, Ti, Ba, B, Si, and Fe; and a to e satisfy 0<a<0.25, 0.5≦b<0.7, 0≦c<1−b, 0≦d≦1, and 0≦e≦1.

According to an embodiment of the present application, there is provided an electric power storage system including a secondary battery; one or more electric devices configured to be supplied with electric power from the secondary battery; and a control section configured to control the supplying of the electric power from the secondary battery to the one or more electric devices, in which the secondary battery includes a cathode, an anode, and an electrolytic solution, the cathode includes a lithium-containing compound, the lithium-containing compound having an average composition represented by a following Formula (1), the lithium-containing compound includes a central section and a surface section, a molar ratio b1 of Mn in the surface section is larger than a molar ratio b2 of Mn in the central section, a molar ratio 1+a1 of Li in the surface section is smaller than a molar ratio 1+a2 of Li in the central section, and a ratio 1+a1/1+a2 between the molar ratio 1+a1 of Li in the surface section and the molar ratio 1+a2 of Li in the central section satisfies 0.5<1+a1/1+a2<1,

Li₁₊ₐ(Mn_{b}Co_{c}Ni_{1-b-c})₁₋ₐM_{d}O₂₋ₑ (1)

where M is one or more of Al, Mg, Zr, Ti, Ba, B, Si, and Fe; and a to e satisfy 0<a<0.25, 0.5≦b<0.7, 0≦c<1−b, 0≦d≦1, and 0≦e≦1.

According to an embodiment of the present application, there is provided an electric power tool including a secondary battery; and a movable section configured to be supplied with electric power from the secondary battery, in which the secondary battery includes a cathode, an anode, and an electrolytic solution, the cathode includes a lithium-containing compound, the lithium-containing compound having an average composition represented by a following Formula (1), the lithium-containing compound includes a central section and a surface section, a molar ratio b1 of Mn in the surface section is larger than a molar ratio b2 of Mn in the central section, a molar ratio 1+a1 of Li in the surface section is smaller than a molar ratio 1+a2 of Li in the central section, and a ratio 1+a1/1+a2 between the molar ratio 1+a1 of Li in the surface section and the molar ratio 1+a2 of Li in the central section satisfies 0.5<1+a1/1+a2<1,

Li₁₊ₐ(Mn_{b}Co_{c}Ni_{1-b-c})₁₋ₐM_{d}O₂₋ₑ (1)

where M is one or more of Al, Mg, Zr, Ti, Ba, B, Si, and Fe; and a to e satisfy 0<a<0.25, 0.5≦b<0.7, 0≦c<1−b, 0≦d≦1, and 0≦e≦1.

According to an embodiment of the present application, there is provided an electronic apparatus including a secondary battery as an electric power supply source, in which the secondary battery includes a cathode, an anode, and an electrolytic solution, the cathode includes a lithium-containing compound, the lithium-containing compound having an average composition represented by a following Formula (1), the lithium-containing compound includes a central section and a surface section, a molar ratio b1 of Mn in the surface section is larger than a molar ratio b2 of Mn in the central section, a molar ratio 1+a1 of Li in the surface section is smaller than a molar ratio 1+a2 of Li in the central section, and a ratio 1+a1/1+a2 between the molar ratio 1+a1 of Li in the surface section and the molar ratio 1+a2 of Li in the central section satisfies 0.5<1+a1/1+a2<1,

Li₁₊ₐ(Mn_{b}Co_{c}Ni_{1-b-c})₁₋ₐM_{d}O₂₋ₑ (1)

where M is one or more of Al, Mg, Zr, Ti, Ba, B, Si, and Fe; and a to e satisfy 0<a<0.25, 0.5≦b<0.7, 0≦c<1−b, 0≦d≦1, and 0≦e≦1.

The foregoing “lithium-containing compound” refers to a secondary particle having an average composition represented by Formula (1). The foregoing “surface section” refers to a section (outer section) existing in the region from the uppermost surface of the lithium-containing compound to the position with a depth corresponding to 10% of a particle diameter (median diameter) of the lithium-containing compound. The foregoing “central section” is a section other than the foregoing surface section out of each of the lithium-containing compound, and is a section (inner section) surrounded by the surface section. The foregoing “molar ratio of Mn” refers to a ratio of Mn in the main constituent elements (Li, Mn, Co, and Ni) of the lithium-containing compound. The foregoing “molar ratio of Li” refers to a ratio of Li in the main constituent elements (Li, Mn, Co, and Ni) as the foregoing molar ratio of Mn does.

According to the secondary battery-use active material, the secondary battery-use electrode, and the secondary battery according to the embodiments of the present application, the lithium-containing compound has an average composition represented by Formula (1), and the molar ratios b1 and b2 of Mn, the molar ratios 1+a1 and 1+a2 of Li, and the ratio 1+a1/1+a2 satisfy the foregoing conditions respectively. Therefore, superior battery characteristics are obtainable thereby. Further, according to the battery pack, the electric vehicle, the electric power storage system, the electric power tool, and the electronic apparatus according to the embodiments of the present application, similar effects are obtainable.

It is to be understood that both the foregoing general description and the following detailed description are exemplary, and are intended to provide further explanation of the technology as claimed.

Additional features and advantages are described herein, and will be apparent from the following Detailed Description and the figures.

### BRIEF DESCRIPTION OF THE FIGURES

The accompanying drawings are included to provide a further understanding of the disclosure, and are incorporated in and constitute a part of this specification. The drawings illustrate embodiments and, together with the specification, serve to explain the principles of the technology.

FIG. 1 is a cross-sectional view illustrating a configuration of a secondary battery-use active material according to an embodiment of the present application.

FIG. 2 is a cross-sectional view illustrating configurations of a secondary battery-use electrode and a secondary battery (cylindrical type) according to embodiments of the present application.

FIG. 3 is a cross-sectional view illustrating an enlarged part of a spirally wound electrode body illustrated in FIG. 2.

FIG. 4 is a perspective view illustrating configurations of another secondary battery-use electrode and another secondary battery (laminated film type) according to embodiments of the present application.

FIG. 5 is a cross-sectional view taken along a line V-V of a spirally wound electrode body illustrated in FIG. 4.

FIG. 6 is a block diagram illustrating a configuration of an application example (battery pack) of the secondary battery.

FIG. 7 is a block diagram illustrating a configuration of an application example (electric vehicle) of the secondary battery.

FIG. 8 is a block diagram illustrating a configuration of an application example (electric power storage system) of the secondary battery.

FIG. 9 is a block diagram illustrating a configuration of an application example (electric power tool) of the secondary battery.

### DETAILED DESCRIPTION

An embodiment of the present application will be described below in detail with reference to the drawings. The description will be given in the following order.

1. Secondary Battery-Use Active Material

2. Application Examples of Secondary Battery-Use Active Material

2-1. Secondary Battery-Use Electrode and Secondary Battery (Cylindrical-Type Lithium Ion Secondary Battery)

2-2. Secondary Battery-Use Electrode and Secondary Battery (Laminated-Film-Type Lithium Ion Secondary Battery)

2-3. Secondary Battery-Use Electrode and Secondary Battery (Lithium Metal Secondary Battery)

3. Applications of Secondary Battery

3-1. Battery Pack

3-2. Electric Vehicle

3-3. Electric Power Storage System

3-4. Electric Power Tool

[1. Secondary Battery-Use Active Material]

A secondary battery-use active material (simply referred to as “active material” below as well) according to an embodiment of the present application is used for an electrode of a secondary battery. The secondary battery may be, for example, a lithium ion secondary battery or the like. The active material described here may be used, for example, as a cathode active material for the secondary battery.

[Composition of Active Material]

The active material contains one or more of particulate lithium-containing compounds (lithium-containing compound particles) having an average composition represented by the following Formula (1), and is capable of inserting and extracting lithium (Li) at the time of charge and discharge.

Li₁₊ₐ(Mn_{b}Co_{c}Ni_{1-b-c})₁₋ₐM_{d}O₂₋ₑ (1)

In Formula 1, M is one or more of aluminum (Al), magnesium (Mg), zirconium (Zr), titanium (Ti), barium (Ba), boron (B), silicon (Si), and iron (Fe); and a to e satisfy 0<a<0.25, 0.5≦b<0.7, 0≦c<1−b, 0≦d≦1, and 0≦e≦1.

The lithium-containing compound particle is an oxide (lithium-transition-metal composite oxide) containing Li, transition metal elements (Mn, Co, and Ni), and other element (M) as constituent elements. The transition metals and the like are in a state of a solid solution.

As seen in the feasible range of a (a>0), since a molar ratio 1+a of Li is typically larger than 1, the lithium-containing compound particle is a so-called lithium-rich compound particle. Further, as seen in the feasible ranges of b and c (b≧0.5 and c≧0), while the lithium-containing compound particle typically contains Mn and Ni as constituent elements out of the foregoing transition metal elements, the lithium-containing compound particle does not necessarily contain Co as a constituent element. Further, as seen in the feasible range of d (d≧0), the lithium-containing compound particle may contain M, or does not necessarily contain M.

One reason why the lithium-containing compound particle is a lithium-rich compound particle is as follows. In this case, the lithium-containing compound particle contains a large amount of Li as a constituent element. Therefore, in an anode at the time of the initial charge, a generation reaction of an irreversible capacity is allowed to be completed substantially.

More specifically, at the time of the initial charge and discharge of a secondary battery, a coating film (such as an SEI film) is formed on the surface of an anode, and therefore, a so-called irreversible capacity is generated. Accordingly, much of Li extracted from a cathode active material at the time of the initial charge is consumed for generating the irreversible capacity. In this case, in the case where the charging voltage at the time of the initial charge of the secondary battery is high (for example, 4.4 V or more), a sufficient amount of Li is extracted from the cathode active material, and therefore, part of Li is consumed for generating the irreversible capacity in the anode. Therefore, a generation reaction of the irreversible capacity is completed substantially at the initial charge and discharge. Therefore, at the time of charge and discharge after the initial charge and discharge, which is substantial usage time of the secondary battery, Li extracted from the cathode active material is consumed for generating a battery capacity. Accordingly, at the time of charge and discharge after the initial charge and discharge, a high battery capacity is stably obtainable.

It is to be noted that, in the case where an anode active material used for the secondary battery together with the cathode active material is a metal-based material, in particular, an oxide, such a fact may cause an irreversible capacity. Li extracted from the cathode active material at the time of the initial charge easily reacts with metal in the metal-based material or oxygen in the oxide irreversibly. The metal-based material may be, for example, a material containing silicon (Si) or tin (Sn) or both as constituent elements, and has an advantage of providing high energy density. More specific examples thereof may include one or more of a simple substance, an alloy, and a compound of Si and a simple substance, an alloy, and a compound of Sn. Although specific examples of the oxide are not particularly limited, examples thereof may include a silicon oxide represented by SiOᵥ (0.2<v<1.4). In particular, in the case where the anode active material is an oxide, the irreversible capacity tends to be increased. It is to be noted that the irreversible capacity is easily increased similarly in the case where the anode active material is low crystalline carbon, amorphous carbon, or the like.

Reasons why a to e in Formula (1) are in the foregoing ranges will be described below.

One reason why a>0 is satisfied is as follows. In the case of a=0, the absolute amount of Li becomes insufficient. Therefore, a generation reaction of an irreversible capacity is not allowed to be completed substantially at the time of the initial charge, and a high battery capacity is not stably obtained at the time of charge and discharge after the initial charge and discharge. In contrast, one reason why a<0.25 is satisfied is as follows. In the case of a≧0.25, Li is consumed for forming a residual product, and therefore, a sufficient battery capacity is not obtainable. Further, in the case where a hydroxide is used as an Li source to manufacture the lithium-containing compound particle, since gas is generated from the hydroxide, the secondary battery is easily swollen. In particular, a may preferably satisfy 0.1<a<0.25, since a higher effect is obtained thereby.

One reason why b≧0.5 is satisfied is as follows. In the case of b<0.5, the absolute amount of Mn becomes insufficient, and therefore, the lithium-containing compound particle is not allowed to contain a sufficient amount of Li as a constituent element. Thereby, a generation reaction of an irreversible capacity is not allowed to be completed substantially at the time of the initial charge, and a high battery capacity is not stably obtained at the time of charge and discharge after the initial charge and discharge. In contrast, one reason why b<0.7 is satisfied is as follows. In the case of b≧0.7, Li₂MnO₄ and/or the like not contributing to a battery capacity is formed, and therefore, the battery capacity is lowered.

One reason why c<1−b is satisfied is as follows. In the case of c≧1−b, the absolute amount of Ni is excessively decreased with respect to the absolute amount of Co, and therefore, a sufficient battery capacity is not obtainable.

One reason why d≦1 is satisfied is as follows. In the case of d>1, in view of number compensation, the lithium-rich lithium-containing compound particle is not allowed to be stably manufactured. Further, in this case, since crystallinity of the lithium-containing compound particle is lowered, and therefore, a sufficient battery capacity is not obtainable.

One reason why e≦1 is satisfied is as follows. In the case of e>1, as in the foregoing case of d, the lithium-rich lithium-containing compound particle is not allowed to be stably manufactured, and a sufficient battery capacity is not obtainable.

It is to be noted that, as described above, the lithium-containing compound particle may contain M as a constituent element, or does not necessarily contain M as a constituent element. In particular, the lithium-containing compound particle may preferably contain M, since the crystal structure of the lithium-containing compound particle is stabilized thereby. Further, even if hydrofluoric acid (hydrogen fluoride) is generated due to a decomposition reaction of an electrolytic solution under high voltage conditions, the surface of the lithium-containing compound particle is less likely to be degraded due to such hydrofluoric acid. Types of M are not particularly limited, as long as M is one or more of the foregoing Al and the like. In particular, M may be preferably one or more of Al, Mg, and Ti, and may be more preferably Al, since a higher effect is obtained thereby.

[Configuration of Active Material]

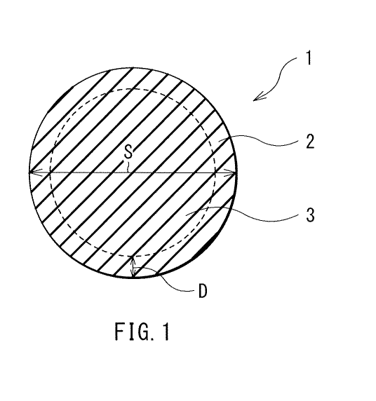

A description will be given of a detailed configuration of the active material referring to FIG. 1. FIG. 1 illustrates a cross-sectional configuration of the active material.

As illustrated in FIG. 1, the active material contains a plurality of lithium-containing compound particles 1. Although not illustrated here, each of the lithium-containing compound particles 1 is an aggregation (secondary particle) of a plurality of primary particles. More specifically, the secondary particle may be, for example, one particulate structure formed by aggregating the plurality of primary particles. The composition shown in Formula (1) represents an average composition of the plurality of lithium-containing compound particles 1.

The composition of each of the lithium-containing compound particles 1, that is, each abundance (each molar ratio) of the respective constituent components (constituent elements) varies depending on locations in each of the lithium-containing compound particles 1, more specifically, satisfies the following three conditions.

Each of the lithium-containing compound particles 1 includes a surface section 2 as an outer section and a central section 3 as an inner section. As described above, the surface section 2 is a section existing in the region from the uppermost surface of each of the lithium-containing compound particles 1 to the position with a depth D corresponding to 10% of a particle diameter (median diameter) S of each of the lithium-containing compound particles 1. In other words, the thickness (the depth D) of the surface section 2 becomes S/10. In contrast, as described above, the central section 3 is a section other than the foregoing surface section 2 out of each of the lithium-containing compound particles 1, and is a section surrounded by the surface section 2.

It is to be noted that, in FIG. 1, for convenience, each of the lithium-containing compound particles 1 is merely sectioned into the outer section (the surface section 2) and the inner section (the central section 3) by regarding the position with the depth D from the uppermost surface of each of the lithium-containing compound particles 1 as a boundary. Therefore, each of the lithium-containing compound particles 1 including the surface section 2 and the central section 3 is merely one structure as a whole, and the surface section 2 and the central section 3 are not physically separated.

As a first condition, a molar ratio b1 of Mn in the surface section 2 is larger than a molar ratio b2 of Mn in the central section 3. As described above, the molar ratio of Mn represents a rate of Mn in the main constituent elements (Li, Mn, Co, and Ni) of each of the lithium-containing compound particles 1.

The composition of the surface section 2 is compared to the composition of the central section 3. In this case, the surface section 2 contains Mn as a constituent element, and the central section 3 also contains Mn as a constituent element. However, the molar ratio b1 of Mn in the surface section 2 is larger than the molar ratio b2 of Mn in the central section 3. One reason for this is that, in this case, the crystal structure of each of the lithium-containing compound particles 1 is stabilized, and therefore, the transition metals are less likely to be eluted from each of the lithium-containing compound particles 1 at the time of charge and discharge. In particular, a ratio b1/b2 between the molar ratio b1 of Mn in the surface section 2 and the molar ratio b2 of Mn in the central section 3 may preferably satisfy 1<b1/b2<1.4.

It is to be noted that the molar ratio of Mn may be distributed in any manner in each of the lithium-containing compound particles 1, as long as the molar ratio of Mn in the surface section 2 is larger than the molar ratio of Mn in the central section 3. In particular, the molar ratio of Mn preferably becomes gradually larger (the molar ratio is sloped) as a location is shifted from the central section 3 toward the surface section 2. One reason for this is that, in this case, the crystal structure of each of the lithium-containing compound particles 1 is further stabilized.

As a second condition, a molar ratio 1+a1 of Li in the surface section 2 is smaller than a molar ratio 1+a2 of Li in the central section 3. As described above, the molar ratio of Li refers to a rate of Li in the main constituent elements (Li, Mn, Co, and Ni) of each of the lithium-containing compound particles 1.

Specifically, as in the first condition, the composition of the surface section 2 is compared to the composition of the central section 3. In this case, while both the surface section 2 and the central section 3 contain Li as a constituent element, the molar ratio 1+a1 of Li in the surface section 2 is smaller than the molar ratio 1+a2 of Li in the central section 3. One reason for this is that, in this case, at the time of charge and discharge, gas generation due to change of the crystal structure of each of the lithium-containing compound particles 1 is suppressed.

It is to be noted that the molar ratio of Li may be distributed in any manner in each of the lithium-containing compound particles 1, as long as the molar ratio of Li in the surface section 2 is smaller than the molar ratio of Li in the central section 3. In particular, the molar ratio Li may preferably become gradually smaller (the molar ratio is sloped) as a location is shifted from the central section 3 toward the surface section 2. One reason for this is that, in this case, gas generation is further suppressed.

As a third condition, a ratio 1+a1/1+a2 between the molar ratio 1+a1 of Li in the surface section 2 and the molar ratio 1+a2 of Li in the central section 3 satisfies 0.5<1+a1/1+a2<1.

In other words, as described above, since the molar ratio 1+a1 of Li in the surface section 2 is smaller than the molar ratio 1+a2 of Li in the central section 3, the ratio 1+a1/1+a2 satisfies a relation 1+a1/1+a2<1. However, it does not mean that any value is feasible for the ratio 1+a1/1+a2 as long as the ratio 1+a1/1+a2 satisfies the foregoing relation. The ratio 1+a1/1+a2 also satisfies a relation 0.5<1+a1/1+a2. In other words, since the molar ratio 1+a1 should be larger than half the molar ratio 1+a2, a relation 1+a1>(1+a2)/2 is also satisfied. One reason for this is that, in this case, a high battery capacity is obtained, and gas generation is suppressed.

One reason why the ratio 1+a1/1+a2 should satisfy the relation 0.5<1+a1/1+a2 as well will be described below for details. In the case where attention is focused on the molar ratios 1+a1 and 1+a2 of Li, as descried above, since the molar ratio 1+a1 is relatively smaller than the molar ratio 1+a2, gas generation is suppressed. However, in the case where the molar ratio 1+a1 becomes relatively and excessively smaller than the molar ratio 1+a2, suppression function of gas generation is saturated, and therefore, a battery capacity is lowered while an amount of gas generation is not changed substantially. On this point, in the case where the ratio 1+a1/1+a2 satisfies the relation 0.5<1+a1/1+a2, a magnitude relation between the molar ratios 1+a1 and 1+a2 becomes appropriate so that the molar ratio 1+a1 is not excessively smaller than the molar ratio 1+a2. Therefore, gas generation is suppressed while lowering of the battery capacity is suppressed.

It is enough that the foregoing three conditions are satisfied in part or all of the surface section 2. In other words, the three conditions may be satisfied in all of the surface section 2, or may be satisfied in part of the surface section 2. Such part of the surface section 2 may be a single portion, and may be formed of a plurality of scattered portions.

Further, it may be preferable that the foregoing first and second conditions are satisfied not only in each of the lithium-containing compound particles 1 as the secondary particles, but also in part or all of the plurality of primary particles forming each of the secondary particles.

Further, as long as the foregoing three conditions for the composition of each of the lithium-containing compound particles 1 are satisfied, each of the surface section 2 and the central section 3 may have any composition.

Specifically, the surface section 2 may have, for example, an average composition represented by the following Formula (2), and the central section 3 may have, for example, an average composition represented by the following Formula (3).

Li₁₊ₐ₁(Mn_{b1}Co_{c1}Ni_{1-b1-c1})₁₋ₐ₁M1_{d1}O₂₋ₑ₁ (2)

In Formula 2, M1 is one or more of Al, Mg, Zr, Ti, Ba, B, Si, and Fe; and a1 to e1 satisfy −0.375<a1<0.25, 0.3<b1<0.7, 0≦c1<1−b, 0≦d1≦1, and 0≦e1≦1.

Li₁₊ₐ₂(Mn_{b2}Co_{c2}Ni_{1-b2-c2})₁₋ₐ₂M2_{d2}O₂₋ₑ₂ (3)

In Formula 3, M2 is one or more of Al, Mg, Zr, Ti, Ba, B, Si, and Fe; and a2 to e2 satisfy 0<a2<0.25, 0.5≦b2<0.7, 0≦c2<1−b, 0≦d2≦1, and 0≦e2≦1.

[Analytical Method of Active Material]

For examining the composition (molar ratios) of the active material, each of the lithium-containing compound particles 1 may be analyzed with the use of various element analytical methods. Examples of the element analytical methods may include one or more of an X-ray diffraction (XRD) method, a time-of-flight secondary ion mass spectrometry (TOF-SIMS) method, a high-frequency inductively-coupled plasma (ICP) emission spectrometry method, a Raman spectrometric analysis method, and an energy dispersive X-ray spectrometric method (EDX).

It is to be noted that in a region where charge and discharge are substantially performed in a secondary battery (in a region where a cathode is opposed to an anode), the composition of each of the lithium-containing compound particles 1 may be changed due to a charge-discharge reaction. Therefore, even if the composition of each of the lithium-containing compound particles 1 is examined after charge and discharge with the use of the X-ray diffraction method or the like, it is possible that the initial composition (composition before charge and discharge) is not allowed to be accurately checked. However, in the case where a region where charge and discharge are not performed (non-charge-discharge region) exists in the cathode, the composition may be preferably examined in the non-charge-discharge region. In the non-charge-discharge region, a state before charge and discharge is substantially retained, and therefore, the composition is allowed to be checked subsequently without relation to presence or absence of charge and discharge. In the foregoing “non-charge-discharge region,” for example, for the purpose of securing safety, an insulating protective tape may be bonded to an end surface of the cathode (cathode active material layer). Therefore, the non-charge-discharge region is a region where charge and discharge are not allowed to be performed due to existence of the insulating protective tape.

[Method of Using Active Material]

In the case where a secondary battery using the active material is charged and discharged, a charging voltage (cathode electric potential: standard electric potential to lithium metal) at the time of the initial charge may be preferably high, and more specifically, may be preferably equal to or more than 4.4 V. One reason for this is that, in this case, a sufficient amount of Li is extracted from the active material at the time of the initial charge, and therefore, a generation reaction of an irreversible capacity is allowed to be subsequently completed in an anode. However, in order to suppress a decomposition reaction of the active material, it may be preferable that the charging voltage at the time of the initial charge is not extremely high, and more specifically, is equal to or less than 4.6 V.

It is to be noted that a charging voltage (cathode electric potential: standard electric potential to lithium metal) at the time of charge after the initial charge is not particularly limited. However, in particular, such a charging voltage may be preferably lower than the charging voltage at the time of the initial charge, and more specifically, may be preferably around 4.3 V. One reason for this is that, in this case, Li is smoothly extracted from the active material for obtaining a battery capacity, and a decomposition reaction of an electrolytic solution, a dissolution reaction of a separator, and the like are suppressed.

[Method of Manufacturing Active Material]

The active material may be manufactured, for example, by the following procedure.

In the case of manufacturing the active material, first, as raw materials, two or more compounds containing the constituent elements of each of the lithium-containing compound particles 1 are prepared. Each of the raw materials may contain only one constituent element out of the constituent elements of each of the lithium-containing compound particles 1, or may contain two or more constituent elements thereof. Although types of the raw materials are not particularly limited, examples thereof may include one or more of an oxide, a hydroxide, a carbonate, a hydrosulfate, and a nitrate salt.

Subsequently, the raw materials are mixed. In this case, the mixture ratio of the raw materials is adjusted so that each of the lithium-containing compound particles 1 having a desired composition is obtained (the molar ratios of the respective constituent elements of each of the lithium-containing compound particles 1 have desired relations with one another).

Subsequently, the mixture of the raw materials is fired. Conditions such as firing temperature and firing time are allowed to be arbitrarily set. By such a firing treatment, a composite oxide containing Li, transition metal elements (Mn and the like), and other element (M) as constituent elements is obtained. The composite oxide is an aggregation (secondary particle) of a plurality of primary particles.

Subsequently, the fired matter is subjected to surface treatment. In this case, the fired matter is soaked into a treatment solution, which is subsequently stirred, and thereafter, the fired matter is taken out from the solution. The treatment solution is used for extracting Li from the composite oxide. Examples of the treatment solution may include one or more of solutions such as ammonium dihydrogen phosphate, nitric acid, sulfuric acid, and manganese sulfate aqueous solution. Conditions such as a solution concentration and soaking time are allowed to be arbitrarily set.

By the surface treatment, in the composite oxide, Li is gradually extracted as a location is shifted from the central section 3 toward the surface section 2. Therefore, the molar ratio of Mn in the surface section 2 is larger than the molar ratio of Mn in the central section 3, and the molar ratio of Li in the surface section 2 is smaller than the molar ratio of Li in the central section 3. In this case, by changing the conditions such as a concentration of the treatment solution and soaking time, the ratio 1+a1/1+a2 is adjustable.

Finally, the fired matter after the surface treatment is fired again. Conditions such as re-firing temperature and re-firing time are allowed to be arbitrarily set. Thereby, the active material is obtained.

[Function and Effect of Active Material]

According to the active material, each of the lithium-containing compound particles has the average composition represented by Formula (1). In addition thereto, the molar ratio b1 of Mn, the molar ratio b2 of Mn, the molar ratio 1+a1 of Li, the molar ratio 1+a2 of Li, and the ratio 1+a1/1+a2 satisfy the first to the third conditions described above. In this case, as described above, since the crystal structure of each of the lithium-containing compound particles is stabilized, the transition metals are less likely to be eluded from the active material at the time of charge and discharge. In addition thereto, while lowering of the battery capacity is suppressed, gas generation is suppressed. Therefore, superior battery characteristics are obtainable.

In particular, in the case where M in Formula (1) is one or more of Al, Mg, and Ti, or a in Formula (1) satisfies 0.1<a<0.25, higher effects are obtainable.

[2. Application Examples of Secondary Battery-Use Active Material]

Next, a description will be given of application examples of the foregoing secondary battery-use active material. The secondary battery-use active material is used for a secondary battery-use electrode and a secondary battery as follows.

[2-1. Secondary Battery-Use Electrode and Secondary Battery (Cylindrical-type Lithium Ion Secondary Battery)]

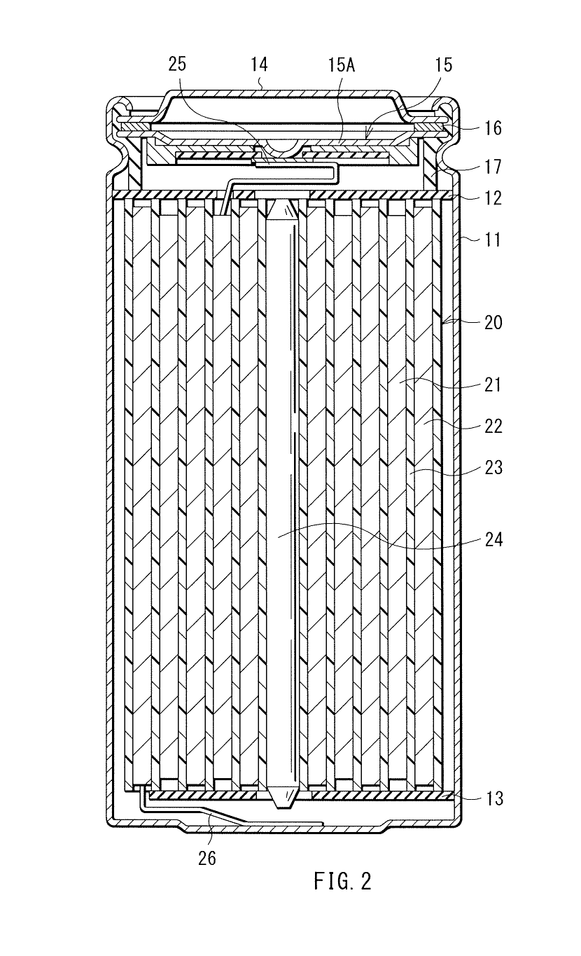

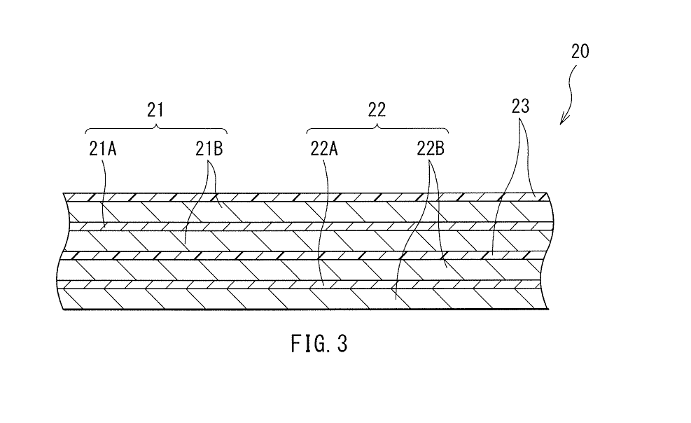

FIG. 2 and FIG. 3 illustrate cross-sectional configurations of a secondary battery. FIG. 3 illustrates enlarged part of a spirally wound electrode body 20 illustrated in FIG. 2. In this example, the secondary battery-use electrode is applied to a cathode 21, for example.

[Whole Configuration of Secondary Battery]

The secondary battery described here is a lithium secondary battery (lithium ion secondary battery) in which a capacity of an anode 22 is obtained by insertion and extraction of Li (lithium ions) as an electrode reactant, and is a so-called cylindrical-type secondary battery.

For example, as illustrated in FIG. 2, the secondary battery may contain a pair of insulating plates 12 and 13 and the spirally wound electrode body 20 inside a battery can 11 in the shape of a substantially-hollow cylinder. In the spirally wound electrode body 20, for example, the cathode 21 and the anode 22 are layered with a separator 23 in between and are spirally wound.

For example, the battery can 11 may have a hollow structure in which one end of the battery can 11 is closed and the other end of the battery can 11 is opened. The battery can 11 may be made of, for example, one or more of iron, aluminum, an alloy thereof, and the like. The surface of the battery can 11 may be plated with nickel or the like. The pair of insulating plates 12 and 13 is arranged to sandwich the spirally wound electrode body 20 in between, and to extend perpendicularly to the spirally wound periphery surface of the spirally wound electrode body 20.

At the open end of the battery can 11, a battery cover 14, a safety valve mechanism 15, and a positive temperature coefficient element (PTC element) 16 are attached by being caulked with a gasket 17. Therefore, the battery can 11 is hermetically sealed. The battery cover 14 may be made of, for example, a material similar to that of the battery can 11. The safety valve mechanism 15 and the PTC element 16 are provided inside the battery cover 14. The safety valve mechanism 15 is electrically connected to the battery cover 14 through the PTC element 16. In the safety valve mechanism 15, in the case where the internal pressure becomes a certain level or more by internal short circuit, external heating, or the like, a disk plate 15A inverts to disconnect electric connection between the battery cover 14 and the spirally wound electrode body 20. The PTC element 16 prevents abnormal heat generation resulting from a large current. As temperature rises, resistance of the PTC element 16 is increased accordingly. The gasket 17 may be made of, for example, an insulating material. The surface of the gasket 17 may be coated with asphalt.

In the center of the spirally wound electrode body 20, for example, a center pin 24 may be inserted. For example, a cathode lead 25 made of a conductive material such as aluminum may be connected to the cathode 21. For example, an anode lead 26 made of a conductive material such as nickel may be connected to the anode 22. For example, the cathode lead 25 may be attached to the safety valve mechanism 15 by welding, and may be electrically connected to the battery cover 14. For example, the anode lead 26 may be attached to the battery can 11 by welding, and may be electrically connected to the battery can 11.

[Cathode]

The cathode 21 has a cathode active material layer 21B on a single surface or both surfaces of a cathode current collector 21A. The cathode current collector 21A may be made of, for example, one or more of conductive materials such as aluminum, nickel, and stainless steel. The cathode active material layer 21B contains, as cathode active materials, one or more of cathode materials capable of inserting and extracting Li. The cathode material contains the foregoing secondary battery-use active material. However, the cathode active material layer 21B may further contain other materials such as a cathode binder and a cathode electric conductor.

The cathode binder may contain one or more of synthetic rubbers, polymer materials, and the like. Examples of the synthetic rubber may include a styrene-butadiene-based rubber, a fluorine-based rubber, and ethylene propylene diene. Examples of the polymer material may include polyvinylidene fluoride and polyimide.

The cathode electric conductor may contain one or more of carbon materials and the like. Examples of the carbon materials may include graphite, carbon black, acetylene black, and Ketjen black. The cathode electric conductor may be a metal material, a conductive polymer, or the like as long as the material has electric conductivity.

It is to be noted that the cathode active material layer 21B may further contain other cathode material as long as the cathode active material layer 21B contains the foregoing secondary battery-use active material as a cathode material. Examples of such other cathode material may include one or more of a lithium-transition-metal composite oxide and a lithium-transition-metal-phosphate compound (excluding a compound corresponding to the secondary battery-use active material). The lithium-transition-metal composite oxide is an oxide containing Li and one or more transition metal elements as constituent elements. The lithium-transition-metal-phosphate compound is a phosphate compound containing Li and one or more transition metal elements as constituent elements.

Examples of the lithium-transition-metal composite oxide may include LiCoO₂, LiNiO₂, and a lithium-nickel-based composite oxide represented by the following Formula (4). Examples of the lithium-transition-metal-phosphate compound may include LiFePO₄ and LiFe₁₋ᵤMᵤPO₄ (u<1), since thereby, a high battery capacity is obtained, and superior cycle characteristics are obtained.

LiNi_{1-z}M_{z}O₂ (4)

In Formula (4), M is one or more of Co, Mn, Fe, Al, V, Sn, Mg, Ti, Sr, Ca, Zr, Mo, Tc, Ru, Ta, W, Re, Yb, Cu, Zn, Ba, B, Cr, Si, Ga, P, Sb, and Nb. z satisfies 0.005<z<0.5.

In addition thereto, the cathode material may be, for example, one or more of an oxide, a disulfide, a chalcogenide, a conductive polymer, and the like. Examples of the oxide may include titanium oxide, vanadium oxide, and manganese dioxide. Examples of the disulfide may include titanium disulfide and molybdenum sulfide. Examples of the chalcogenide may include niobium selenide. Examples of the conductive polymer may include sulfur, polyaniline, and polythiophene. However, the cathode material is not limited to any of the foregoing materials, and may be other material.

[Anode]

The anode 22 has an anode active material layer 22B on a single surface or both surfaces of an anode current collector 22A.

The anode current collector 22A may be made of, for example, one or more of electrically-conductive materials such as copper, nickel, and stainless steel. The surface of the anode current collector 22A may be preferably roughened. Thereby, due to a so-called anchor effect, adhesion characteristics of the anode active material layer 22B with respect to the anode current collector 22A are improved. In this case, it is enough that the surface of the anode current collector 22A in a region opposed to the anode active material layer 22B is roughened at minimum. Examples of roughening methods may include a method of forming fine particles by utilizing electrolytic treatment. The electrolytic treatment is a method of forming the fine particles on the surface of the anode current collector 22A with the use of an electrolytic method in an electrolytic bath to provide concavity and convexity on the surface of the anode current collector 22A. A copper foil fabricated by an electrolytic method is generally called “electrolytic copper foil.”

The anode active material layer 22B contains one or more of anode materials capable of inserting and extracting Li as anode active materials. The anode active material layer 22B may further contain other materials such as an anode binder and an anode electric conductor. Details of the anode binder and the anode electric conductor may be, for example, similar to those of the cathode binder and the cathode electric conductor. However, the chargeable capacity of the anode material may be preferably larger than the discharge capacity of the cathode 21 in order to prevent lithium metal from being unintentionally precipitated on the anode 22 in the middle of charge. In other words, the electrochemical equivalent of the anode material capable of inserting and extracting Li may be preferably larger than the electrochemical equivalent of the cathode 21.

Examples of the anode material may include one or more of carbon materials. In the carbon material, its crystal structure change at the time of insertion and extraction of Li is extremely small, and therefore, the carbon material provides high energy density and superior cycle characteristics. Further, the carbon material functions as an anode electric conductor as well. Examples of the carbon material may include graphitizable carbon, non-graphitizable carbon, and graphite. However, the spacing of (002) plane in the non-graphitizable carbon may be preferably equal to or greater than 0.37 nm, and the spacing of (002) plane in graphite may be preferably equal to or smaller than 0.34 nm. More specifically, examples of the carbon material may include pyrolytic carbons, cokes, glassy carbon fiber, an organic polymer compound fired body, activated carbon, and carbon blacks. Examples of the cokes may include pitch coke, needle coke, and petroleum coke. The organic polymer compound fired body is obtained by firing (carbonizing) a polymer compound such as a phenol resin and a furan resin at appropriate temperature. In addition thereto, the carbon material may be low crystalline carbon or amorphous carbon heat-treated at temperature of about 1000 deg C. or less. It is to be noted that the shape of the carbon material may be any of a fibrous shape, a spherical shape, a granular shape, and a scale-like shape.

Further, the anode material may be, for example, a material (metal-based material) containing one or more of metal elements and metalloid elements as constituent elements, since higher energy density is thereby obtained. Such a metal-based material may be a simple substance, an alloy, or a compound, may be two or more thereof, or may have one or more phases thereof in part or all thereof. “Alloy” includes a material containing one or more metal elements and one or more metalloid elements, in addition to a material configured of two or more metal elements. Further, the “alloy” may contain a nonmetallic element. Examples of the structure thereof may include a solid solution, a eutectic crystal (eutectic mixture), an intermetallic compound, and a structure in which two or more thereof coexist.

Examples of the foregoing metal elements and the foregoing metalloid elements may include one or more of metal elements and metalloid elements capable of forming an alloy with Li. Specific examples thereof may include Mg, B, Al, Ga, In, Si, Ge, Sn, Pb, Bi, Cd, Ag, Zn, Hf, Zr, Y, Pd, and Pt. In particular, Si or Sn or both may be preferable. One reason for this is that Si and Sn have a superior ability of inserting and extracting Li, and therefore, provide high energy density.

A material containing Si or Sn or both as constituent elements may be any of a simple substance, an alloy, and a compound of Si, may be any of a simple substance, an alloy, and a compound of Sn, may be two or more thereof, or may have one or more phases thereof in part or all thereof. It is to be noted that the simple substance merely refers to a general simple substance (a small amount of impurity may be therein contained), and does not necessarily refer to a purity 100% simple substance.

The alloys of Si may contain, for example, one or more of elements such as Sn, Ni, Cu, Fe, Co, Mn, Zn, In, Ag, Ti, Ge, Bi, Sb, and Cr as constituent elements other than Si. The compounds of Si may contain, for example, one or more of C, O, and the like as constituent elements other than Si. It is to be noted that, for example, the compounds of Si may contain one or more of the elements described for the alloys of Si as constituent elements other than Si.

Examples of the alloys of Si and the compounds of Si may include SiB₄, SiB₆, Mg₂Si, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, SiOᵥ (0<v≦2), and LiSiO. v in SiOᵥ may be in the range of 0.2<v<1.4.

The alloys of Sn may contain, for example, one or more of elements such as Si, Ni, Cu, Fe, Co, Mn, Zn, In, Ag, Ti, Ge, Bi, Sb, and Cr as constituent elements other than Sn. The compounds of Sn may contain, for example, one or more of elements such as C and O as constituent elements other than Sn. It is to be noted that the compounds of Sn may contain, for example, one or more of the elements described for the alloys of Sn as constituent elements other than Sn. Examples of the alloys of Sn and the compounds of Sn may include SnO_{w} (0<w≦2), SnSiO₃, LiSnO, and Mg₂Sn.

Further, as a material containing Sn as a constituent element, for example, a material containing a second constituent element and a third constituent element in addition to Sn as a first constituent element may be preferable. Examples of the second constituent element may include one or more of elements such as Co, Fe, Mg, Ti, V, Cr, Mn, Ni, Cu, Zn, Ga, Zr, Nb, Mo, Ag, In, Ce, Hf, Ta, W, Bi, and Si. Examples of the third constituent element may include one or more of elements such as B, C, Al, and P. In the case where the second constituent element and the third constituent element are contained, a high battery capacity, superior cycle characteristics, and the like are obtained.

In particular, a material (SnCoC-containing material) containing Sn, Co, and C as constituent elements may be preferable. The composition of the SnCoC-containing material may be, for example, as follows. That is, the C content may be from 9.9 mass % to 29.7 mass % both inclusive, and the ratio of Sn and Co contents (Co/(Sn+Co)) may be from 20 mass % to 70 mass % both inclusive, since high energy density is obtained in such a composition range.

It may be preferable that the SnCoC-containing material have a phase containing Sn, Co, and C. Such a phase may be preferably low-crystalline or amorphous. The phase is a phase (reaction phase) capable of reacting with Li. Due to existence of the reaction phase, superior characteristics are obtained. The half bandwidth of the diffraction peak obtained by X-ray diffraction of the phase may be preferably equal to or greater than 1 deg based on diffraction angle of 2θ in the case where CuKα ray is used as a specific X ray, and the insertion rate is 1 deg/min. Thereby, Li is more smoothly inserted and extracted, and reactivity with the electrolytic solution is decreased. It is to be noted that, in some cases, the SnCoC-containing material includes a phase containing a simple substance or part of the respective constituent elements in addition to the low-crystalline phase or the amorphous phase.

Whether or not the diffraction peak obtained by the X-ray diffraction corresponds to the reaction phase capable of reacting with Li is allowed to be easily determined by comparison between X-ray diffraction charts before and after electrochemical reaction with Li. For example, if the position of the diffraction peak after electrochemical reaction with Li is changed from the position of the diffraction peak before the electrochemical reaction with Li, the obtained diffraction peak corresponds to the reaction phase capable of reacting with Li. In this case, for example, the diffraction peak of the low crystalline reaction phase or the amorphous reaction phase is seen in the range of 2θ=from 20 deg to 50 deg both inclusive. Such a reaction phase may have, for example, the foregoing respective constituent elements, and the low crystalline or amorphous structure thereof possibly results from existence of C mainly.

In the SnCoC-containing material, part or all of C as a constituent element may be preferably bonded to a metal element or a metalloid element as other constituent element, since cohesion or crystallization of Sn and/or the like is suppressed accordingly. The bonding state of elements is allowed to be checked by, for example, an X-ray photoelectron spectroscopy method (XPS). In a commercially available device, for example, as a soft X ray, Al—Kα ray, Mg—Kα ray, or the like may be used. In the case where part or all of C are bonded to a metal element, a metalloid element, or the like, the peak of a synthetic wave of is orbit of C (C1s) is shown in a region lower than 284.5 eV. It is to be noted that in the device, energy calibration is made so that the peak of 4f orbit of Au atom (Au4f) is obtained in 84.0 eV. At this time, in general, since surface contamination carbon exists on the material surface, the peak of C1s of the surface contamination carbon is regarded as 284.8 eV, which is used as the energy standard. In XPS measurement, the waveform of the peak of C1s is obtained as a form including the peak of the surface contamination carbon and the peak of carbon in the SnCoC-containing material. Therefore, for example, analysis may be made with the use of commercially-available software to isolate both peaks from each other. In the waveform analysis, the position of the main peak existing on the lowest binding energy side is the energy standard (284.8 eV).

It is to be noted that the SnCoC-containing material is not limited to the material (SnCoC) formed of only Sn, Co, and C as constituent elements. In other words, the SnCoC-containing material may further contain, for example, one or more of Si, Fe, Ni, Cr, In, Nb, Ge, Ti, Mo, Al, P, Ga, Bi, and the like as constituent elements, in addition to Sn, Co, and C.

In addition to the SnCoC-containing material, a material containing Sn, Co, Fe, and C as constituent elements (SnCoFeC-containing material) may be also preferable. The composition of the SnCoFeC-containing material may be any composition. For example, the composition in which the Fe content is set small may be as follows. That is, the C content may be from 9.9 mass % to 29.7 mass % both inclusive, the Fe content may be from 0.3 mass % to 5.9 mass % both inclusive, and the ratio of contents of Sn and Co (Co/(Sn+Co)) may be from 30 mass % to 70 mass % both inclusive. Further, the composition in which the Fe content is set large is as follows. That is, the C content is from 11.9 mass % to 29.7 mass % both inclusive, the ratio of contents of Sn, Co, and Fe ((Co+Fe)/(Sn+Co+Fe)) is from 26.4 mass % to 48.5 mass % both inclusive, and the ratio of contents of Co and Fe (Co/(Co+Fe)) is from 9.9 mass % to 79.5 mass % both inclusive. In such a composition range, high energy density is obtained. The physical properties (such as half bandwidth) of the SnCoFeC-containing material are similar to those of the foregoing SnCoC-containing material.

In addition thereto, the anode material may be, for example, one or more of a metal oxide, a polymer compound, and the like. Examples of the metal oxide may include iron oxide, ruthenium oxide, and molybdenum oxide. Examples of the polymer compound may include polyacetylene, polyaniline, and polypyrrole. However, the anode material is not limited to the foregoing material, and may be other material.

The anode active material layer 22B may be formed by, for example, one or more of a coating method, a gas-phase method, a liquid-phase method, a spraying method, and a firing method (sintering method). The coating method may be a method in which, for example, after a particulate (powder) anode active material is mixed with an anode binder and/or the like, the mixture is dispersed in a solvent such as an organic solvent, and the anode current collector 22A is coated with the resultant. Examples of the gas-phase method may include a physical deposition method and a chemical deposition method. More specifically, examples thereof may include a vacuum evaporation method, a sputtering method, an ion plating method, a laser ablation method, a thermal chemical vapor deposition method, a chemical vapor deposition (CVD) method, and a plasma chemical vapor deposition method. Examples of the liquid-phase method may include an electrolytic plating method and an electroless plating method. The spraying method is a method in which an anode active material in a fused state or a semi-fused state is sprayed to the anode current collector 22A. The firing method may be, for example, a method in which after the anode current collector 22A is coated by a coating method, heat treatment is performed at temperature higher than the melting point of the anode binder and/or the like. Examples of the firing method may include an atmosphere firing method, a reactive firing method, and a hot press firing method.

In the secondary battery, as described above, in order to prevent lithium metal from being unintentionally precipitated on the anode 22 in the middle of charge, the electrochemical equivalent of the anode material capable of inserting and extracting Li may be preferably larger than the electrochemical equivalent of the cathode. Further, in the case where the open circuit voltage (that is, a battery voltage) at the time of completely-charged state is equal to or greater than 4.25 V, the extraction amount of lithium ions per unit mass is larger than that in the case where the open circuit voltage is 4.2 V even if the same cathode active material is used. Therefore, amounts of the cathode active material and the anode active material are adjusted accordingly. Thereby, high energy density is obtainable.

[Separator]

The separator 23 separates the cathode 21 from the anode 22, and passes lithium ions while preventing current short circuit resulting from contact of both electrodes. The separator 23 may be, for example, a porous film made of a synthetic resin, ceramics, or the like. The separator 23 may be a laminated film in which two or more types of porous films are laminated. Examples of the synthetic resin may include polytetrafluoroethylene, polypropylene, and polyethylene.

In particular, the separator 23 may include, for example, a polymer compound layer provided on one surface or both surfaces of the foregoing porous film (base material layer). One reason for this is that, thereby, adhesion characteristics of the separator 23 with respect to the cathode 21 and the anode 22 are improved, and therefore, distortion of the spirally wound electrode body 20 is suppressed. Therefore, a decomposition reaction of the electrolytic solution is suppressed, and liquid leakage of the electrolytic solution with which the base material layer is impregnated is suppressed. Accordingly, even if charge and discharge are repeated, the resistance is less likely to be increased, and battery swelling is suppressed.

The polymer compound layer may contain, for example, a polymer material such as polyvinylidene fluoride, since such a polymer material has superior physical strength and is electrochemically stable. However, the polymer material may be a polymer material other than polyvinylidene fluoride. The polymer compound layer may be formed as follows, for example. That is, after a solution in which the polymer material is dissolved is prepared, the base material layer is coated with the solution, and the resultant is subsequently dried. Alternatively, the base material layer may be soaked in the solution and may be subsequently dried.

[Electrolytic Solution]

The separator 23 is impregnated with an electrolytic solution as a liquid electrolyte. The electrolytic solution contains a solvent and an electrolyte salt, and may further contain other material such as an additive.

The solvent contains one or more of nonaqueous solvents such as an organic solvent. Examples of the nonaqueous solvents may include a cyclic ester carbonate, a chain ester carbonate, lactone, a chain carboxylic ester, and nitrile, since a superior battery capacity, superior cycle characteristics, superior conservation characteristics, and the like are thereby obtained. Examples of the cyclic ester carbonate may include ethylene carbonate, propylene carbonate, and butylene carbonate. Examples of the chain ester carbonate may include dimethyl carbonate, diethyl carbonate, ethyl methyl carbonate, and methylpropyl carbonate. Examples of the lactone may include γ-butyrolactone and γ-valerolactone. Examples of the carboxylic ester may include methyl acetate, ethyl acetate, methyl propionate, ethyl propionate, methyl butyrate, methyl isobutyrate, methyl trimethylacetate, and ethyl trimethylacetate. Examples of the nitrile may include acetonitrile, glutaronitrile, adiponitrile, methoxyacetonitrile, and 3-methoxypropionitrile.

In addition thereto, the nonaqueous solvent may be, for example, 1,2-dimethoxyethane, tetrahydrofuran, 2-methyltetrahydrofuran, tetrahydropyran, 1,3-dioxolane, 4-methyl-1,3-dioxolane, 1,3-dioxane, 1,4-dioxane, N,N-dimethylformamide, N-methylpyrrolidinone, N-methyloxazolidinone, N,N′-dimethylimidazolidinone, nitromethane, nitroethane, sulfolane, trimethyl phosphate, or dimethyl sulfoxide, since thereby, a similar advantage is obtained.

In particular, one or more of ethylene carbonate, propylene carbonate, dimethyl carbonate, diethyl carbonate, and ethyl methyl carbonate may be preferable, since a further superior battery capacity, further superior cycle characteristics, further superior conservation characteristics, and the like are thereby obtained. In this case, a combination of a high viscosity (high dielectric constant) solvent (for example, specific dielectric constant ∈≧30) such as ethylene carbonate and propylene carbonate and a low viscosity solvent (for example, viscosity≦1 mPa·s) such as dimethyl carbonate, ethylmethyl carbonate, and diethyl carbonate may be more preferable. One reason for this is that the dissociation property of the electrolyte salt and ion mobility are thereby improved.

In particular, the solvent may preferably contain one or more of an unsaturated cyclic ester carbonate, a halogenated ester carbonate, sultone (cyclic sulfonic ester), an acid anhydride, and the like. One reason for this is that, in this case, chemical stability of the electrolytic solution is improved. The unsaturated cyclic ester carbonate is a cyclic ester carbonate including one or more unsaturated carbon bonds (carbon-carbon double bonds). Examples of the unsaturated cyclic ester carbonate may include vinylene carbonate, vinylethylene carbonate, and methyleneethylene carbonate. The halogenated ester carbonate is a cyclic ester carbonate having one or more halogens as constituent elements or a chain ester carbonate having one or more halogens as constituent elements. Examples of the cyclic halogenated ester carbonate may include 4-fluoro-1,3-dioxolane-2-one and 4,5-difluoro-1,3-dioxolane-2-one. Examples of the chain halogenated ester carbonate may include fluoromethyl methyl carbonate, bis(fluoromethyl) carbonate, and difluoromethyl methyl carbonate. Examples of the sultone may include propane sultone and propene sultone. Examples of the acid anhydrides may include a succinic anhydride, an ethane disulfonic anhydride, and a sulfobenzoic anhydride. However, the solvent is not limited to the foregoing material, and may be other material.

The electrolyte salt may contain, for example, one or more of salts such as a lithium salt. However, the electrolyte salt may contain a salt other than the lithium salt. Examples of the salt other than the lithium salt may include a light metal salt other than the lithium salt.

Examples of the lithium salts may include lithium hexafluorophosphate (LiPF₆), lithium tetrafluoroborate (LiBF₄), lithium perchlorate (LiClO₄), lithium hexafluoroarsenate (LiAsF₆), lithium tetraphenylborate (LiB(C₆H₅)₄), lithium methanesulfonate (LiCH₃SO₃), lithium trifluoromethane sulfonate (LiCF₃SO₃), lithium tetrachloroaluminate (LiAlCl₄), dilithium hexafluorosilicate (Li₂SiF₆), lithium chloride (LiCl), and lithium bromide (LiBr). Thereby, a superior battery capacity, superior cycle characteristics, superior conservation characteristics, and the like are obtained.

In particular, one or more of LiPF₆, LiBF₄, LiClO₄, and LiAsF₆ may be preferable, and LiPF₆ may be more preferable, since the internal resistance is thereby lowered, and therefore, a higher effect is obtained. However, the electrolyte salt is not limited to the foregoing materials, and may be other material.

Although the content of the electrolyte salt is not particularly limited, the content thereof may be preferably from 0.3 mol/kg to 3.0 mol/kg both inclusive with respect to the solvent, since high ion conductivity is obtained thereby.

[Operation of Secondary Battery]

The secondary battery operates, for example, as follows. At the time of charge, lithium ions extracted from the cathode 21 are inserted in the anode 22 through the electrolytic solution. In contrast, at the time of discharge, lithium ions extracted from the anode 22 are inserted in the cathode 21 through the electrolytic solution.

In this case, as described above, in order to subsequently complete a generation reaction of an irreversible capacity in the anode 22 at the time of the initial charge, a charging voltage (such as 4.6 V) at the time of the initial charge may be preferably higher than a charging voltage (such as 4.35 V) at the time of charge after the initial charge. More specifically, the secondary battery may be preferably charged until the voltage reaches a voltage equal to or larger than 4.4 V (standard electric potential to lithium metal).

[Method of Manufacturing Secondary Battery]

The secondary battery may be manufactured, for example, by the following procedure.

First, the cathode 21 is fabricated. The foregoing secondary battery-use active material as a cathode active material is mixed with a cathode binder, a cathode electric conductor, and/or the like to prepare a cathode mixture. Subsequently, the cathode mixture is dispersed in an organic solvent or the like to obtain paste cathode mixture slurry. Subsequently, both surfaces of the cathode current collector 21A are coated with the cathode mixture slurry, which is dried to form the cathode active material layer 21B. Subsequently, the cathode active material layer 21B is compression-molded with the use of a roll pressing machine and/or the like. In this case, compression-molding may be performed while heating, or compression-molding may be repeated several times.

Further, the anode 22 is fabricated by a procedure similar to that of the cathode 21 described above. The anode active material is mixed with an anode binder, an anode electric conductor, and/or the like to prepare an anode mixture, which is subsequently dispersed in an organic solvent or the like to form paste anode mixture slurry. Subsequently, both surfaces of the anode current collector 22A are coated with the anode mixture slurry, which is dried to form the anode active material layer 22B. Thereafter, the anode active material layer 22B is compression-molded.

Finally, the secondary battery is assembled using the cathode 21 and the anode 22. The cathode lead 25 is attached to the cathode current collector 21A by a welding method and/or the like, and the anode lead 26 is attached to the anode current collector 22A by a welding method and/or the like. Subsequently, the cathode 21 and the anode 22 are layered with the separator 23 in between and are spirally wound, and the spirally wound electrode body 20 is thereby fabricated. Thereafter, the center pin 24 is inserted in the center of the spirally wound electrode body 20. Subsequently, the spirally wound electrode body 20 is sandwiched between the pair of insulating plates 12 and 13, and is contained in the battery can 11. In this case, the end tip of the cathode lead 25 is attached to the safety valve mechanism 15 by a welding method and/or the like, and the end tip of the anode lead 26 is attached to the battery can 11 by a welding method and/or the like. Subsequently, the electrolytic solution in which the electrolyte salt is dispersed in the solvent is injected into the battery can 11, and the separator 23 is impregnated with the electrolytic solution. Subsequently, at the open end of the battery can 11, the battery cover 14, the safety valve mechanism 15, and the PTC element 16 are fixed by being caulked with the gasket 17.

[Function and Effect of Secondary Battery]

According to the cylindrical-type secondary battery, the cathode active material layer 21B of the cathode 21 contains the foregoing secondary battery-use active material as a cathode active material. In this case, as described above, the transition metal is less likely to be eluded from the cathode active material at the time of charge and discharge. In addition thereto, while lowering of the battery capacity is suppressed, gas generation is suppressed. Thereby, even if the secondary battery is repeatedly charged and discharged, and the secondary battery is conserved in high temperature environment, the discharge capacity is less likely to be decreased. Further, the secondary battery is less likely to be swollen. Accordingly, superior battery characteristics are obtainable. Other functions and other effects are similar to those of the secondary battery-use active material.

[2-2. Secondary Battery-Use Electrode and Secondary Battery (Laminated-Film-Type Lithium Ion Secondary Battery)]

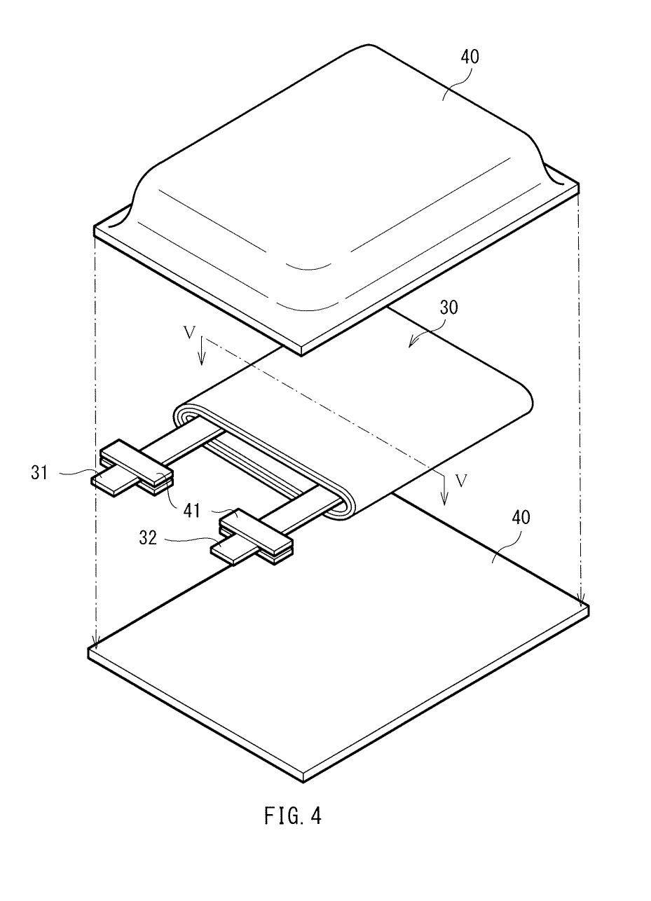

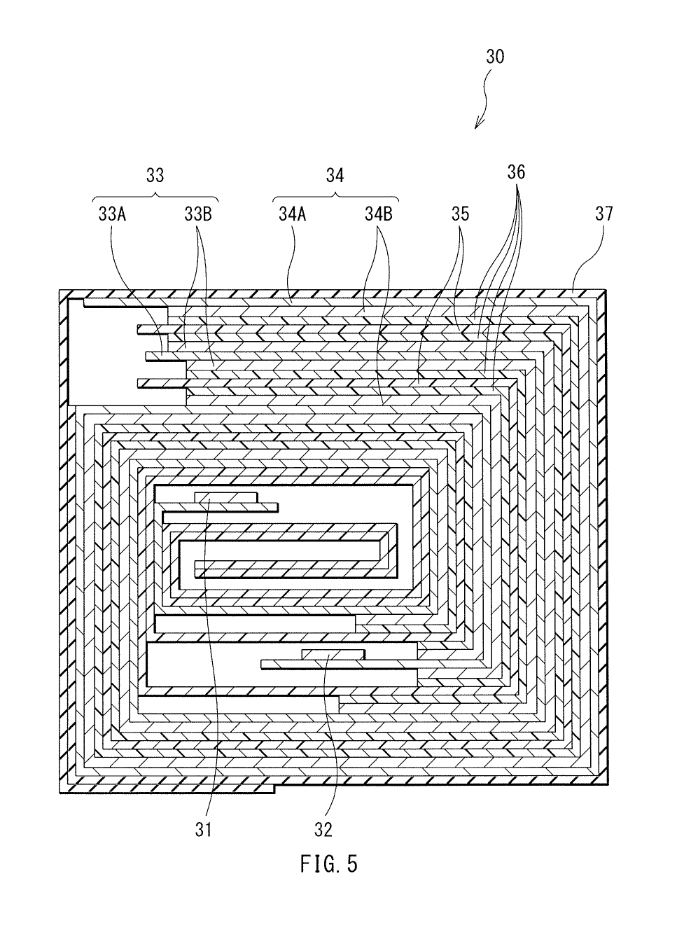

FIG. 4 illustrates an exploded perspective configuration of another secondary battery. FIG. 5 illustrates an enlarged cross-section taken along a line V-V of a spirally wound electrode body 30 illustrated in FIG. 4. However, FIG. 4 illustrates a state that the spirally wound electrode body 30 is separated from two outer package members 40. In the following description, the elements of the cylindrical-type secondary battery described above will be used as necessary.

[Whole Configuration of Secondary Battery]

The secondary battery described here is a so-called laminated-film-type lithium ion secondary battery. For example, as illustrated in FIG. 4, the spirally wound electrode body 30 may be contained in a film-like outer package member 40. In the spirally wound electrode body 30, for example, a cathode 33 and an anode 34 may be layered with a separator 35 and an electrolyte layer 36 in between and may be spirally wound. A cathode lead 31 is attached to the cathode 33, and an anode lead 32 is attached to the anode 34. The outermost periphery of the spirally wound electrode body 30 is protected by a protective tape 37.

The cathode lead 31 and the anode lead 32 may be, for example, led out from inside to outside of the outer package member 40 in the same direction. The cathode lead 31 may be made of, for example, an electrically-conductive material such as aluminum, and the anode lead 32 may be made of, for example, an electrically-conducive material such as copper, nickel, and stainless steel. These electrically-conductive materials may be in the shape of, for example, a thin plate or mesh.

The outer package member 40 may be a laminated film in which, for example, a fusion bonding layer, a metal layer, and a surface protective layer are laminated in this order. The outer package member 40 may be obtained by, for example, layering two laminated films so that the fusion bonding layers are opposed to the spirally wound electrode body 30, and subsequently fusion bonding outer edges of the respective fusion bonding layers. However, the two laminated films may be bonded to each other by an adhesive or the like. Examples of the fusion bonding layer may include a film made of polyethylene, and polypropylene. Examples of the metal layer may include an aluminum foil. Examples of the surface protective layer may include a film made of nylon, polyethylene terephthalate, or the like.

In particular, the outer package member 40 may preferably be an aluminum laminated film in which a polyethylene film, an aluminum foil, and a nylon film are laminated in this order. However, the outer package member 40 may be a laminated film having other laminated structure, a polymer film such as polypropylene, or a metal film.

For example, an adhesive film 41 to prevent outside air intrusion may be inserted between the outer package member 40 and the cathode lead 31 and between the outer package member 40 and the anode lead 32. The adhesive film 41 is made of a material having adhesion characteristics with respect to the cathode lead 31 and the anode lead 32. Examples of the material having adhesion characteristics may include a polyolefin resin. More specific examples thereof may include polyethylene, polypropylene, modified polyethylene, and modified polypropylene.

The cathode 33 may have, for example, a cathode active material layer 33B on both surfaces of a cathode current collector 33A. The anode 34 may have, for example, an anode active material layer 34B on both surfaces of an anode current collector 34A. The configurations of the cathode current collector 33A, the cathode active material layer 33B, the anode current collector 34A, and the anode active material layer 34B are similar to the configurations of the cathode current collector 21A, the cathode active material layer 21B, the anode current collector 22A, and the anode active material layer 22B, respectively. In other words, the cathode active material layer 33B of the cathode 33 as a secondary battery-use electrode contains the foregoing secondary battery-use active material as a cathode active material. The configuration of the separator 35 is similar to the configuration of the separator 23.

[Electrolyte Layer]

In the electrolyte layer 36, an electrolytic solution is held by a polymer compound. The electrolyte layer 36 is a so-called gel electrolyte, since thereby, high ion conductivity (for example, 1 mS/cm or more at room temperature) is obtained and liquid leakage of the electrolytic solution is prevented. The electrolyte layer 36 may further contain other material such as an additive.

The polymer compound contains one or more of polymer materials. Examples of the polymer materials may include polyacrylonitrile, polyvinylidene fluoride, polytetrafluoroethylene, polyhexafluoropropylene, polyethylene oxide, polypropylene oxide, polyphosphazene, polysiloxane, polyvinyl fluoride, polyvinyl acetate, polyvinyl alcohol, polymethacrylic acid methyl, polyacrylic acid, polymethacrylic acid, styrene-butadiene rubber, nitrile-butadiene rubber, polystyrene, and polycarbonate. In addition thereto, the polymer material may be a copolymer. The copolymer may be, for example, a copolymer of vinylidene fluoride and hexafluoropylene. In particular, polyvinylidene fluoride or the copolymer of vinylidene fluoride and hexafluoropylene may be preferable, and polyvinylidene fluoride may be more preferable, since such a polymer compound is electrochemically stable.

For example, the composition of the electrolytic solution may be similar to the composition of the electrolytic solution of the cylindrical-type secondary battery. However, in the electrolyte layer 36 as a gel electrolyte, the solvent of the electrolytic solution refers to a wide concept including not only a liquid solvent but also a material having ion conductivity capable of dissociating the electrolyte salt. Therefore, in the case where a polymer compound having ion conductivity is used, the polymer compound is also included in the solvent.

It is to be noted that the electrolytic solution may be used as it is instead of the gel electrolyte layer 36. In this case, the separator 35 is impregnated with the electrolytic solution.

[Operation of Secondary Battery]

The secondary battery may operate, for example, as follows. At the time of charge, lithium ions extracted from the cathode 33 may be inserted in the anode 34 through the electrolyte layer 36. In contrast, at the time of discharge, lithium ions extracted from the anode 34 may be inserted in the cathode 33 through the electrolyte layer 36. In this case, again, in order to substantially complete a generation reaction of an irreversible capacity in the anode 34 at the time of the initial charge, a charging voltage at the time of the initial charge may be preferably higher than a charging voltage at the time of charge after the initial charge.

[Method of Manufacturing Secondary Battery]

The secondary battery including the gel electrolyte layer 36 may be manufactured, for example, by the following three types of procedures.

In the first procedure, the cathode 33 and the anode 34 are fabricated by a fabrication procedure similar to that of the cathode 21 and the anode 22. In this case, the cathode 33 is fabricated by forming the cathode active material layer 33B on both surfaces of the cathode current collector 33A, and the anode 34 is fabricated by forming the anode active material layer 34B on both surfaces of the anode current collector 34A. Subsequently, a precursor solution containing an electrolytic solution, a polymer compound, and a solvent such as an organic solvent is prepared. Thereafter, the cathode 33 and the anode 34 are coated with the precursor solution to form the gel electrolyte layer 36. Subsequently, the cathode lead 31 is attached to the cathode current collector 33A by a welding method and/or the like, and the anode lead 32 is attached to the anode current collector 34A by a welding method and/or the like. Subsequently, the cathode 33 and the anode 34 are layered with the separator 35 in between and are spirally wound to fabricate the spirally wound electrode body 30. Thereafter, the protective tape 37 is adhered to the outermost periphery thereof. Subsequently, after the spirally wound electrode body 30 is sandwiched between two pieces of film-like outer package members 40, the outer edges of the outer package members 40 are bonded by a thermal fusion bonding method and/or the like to enclose the spirally wound electrode body 30 into the outer package members 40. In this case, the adhesive films 41 are inserted between the cathode lead 31 and the outer package member 40 and between the anode lead 32 and the outer package member 40.

In the second procedure, the cathode lead 31 is attached to the cathode 33, and the anode lead 32 is attached to the anode 34. Subsequently, the cathode 33 and the anode 34 are layered with the separator 35 in between and are spirally wound to fabricate a spirally wound body as a precursor of the spirally wound electrode body 30. Thereafter, the protective tape 37 is adhered to the outermost periphery thereof. Subsequently, after the spirally wound body is sandwiched between two pieces of the film-like outer package members 40, the outermost peripheries except for one side are bonded by a thermal fusion bonding method and/or the like, and the spirally wound body is contained in the pouch-like outer package member 40. Subsequently, an electrolytic solution, a monomer as a raw material for the polymer compound, a polymerization initiator, and other materials such as a polymerization inhibitor are mixed to prepare a composition for electrolyte. Subsequently, the composition for electrolyte is injected into the pouch-like outer package member 40. Thereafter, the outer package member 40 is hermetically sealed by a thermal fusion bonding method and/or the like. Subsequently, the monomer is thermally polymerized, and thereby, a polymer compound is formed. As a result, the polymer compound is impregnated with the electrolytic solution, the polymer compound is gelated, and accordingly, the electrolyte layer 36 is formed.

In the third procedure, the spirally wound body is fabricated and contained in the pouch-like outer package member 40 in a manner similar to that of the foregoing second procedure, except that the separator 35 with both surfaces coated with a polymer compound is used. Examples of the polymer compound with which the separator 35 is coated may include a polymer (a homopolymer, a copolymer, or a multicomponent copolymer) containing vinylidene fluoride as a component. Specific examples of the homopolymer may include polyvinylidene fluoride. Examples of the copolymer may include a binary copolymer containing vinylidene fluoride and hexafluoro propylene as components. Examples of the multicomponent copolymer may include a ternary copolymer containing vinylidene fluoride, hexafluoro propylene, and chlorotrifluoroethylene as components. It is to be noted that, in addition to the polymer containing vinylidene fluoride as a component, other one or more polymer compounds may be used. Subsequently, an electrolytic solution is prepared and injected into the outer package member 40. Thereafter, the opening of the outer package member 40 is hermetically sealed by a thermal fusion bonding method and/or the like. Subsequently, the resultant is heated while a weight is applied to the outer package member 40, and the separator 35 is adhered to the cathode 33 and the anode 34 with the polymer compound in between. As a result, the polymer compound is impregnated with the electrolytic solution, the polymer compound is gelated, and accordingly, the electrolyte layer 36 is formed.

In the third procedure, swelling of the secondary battery is suppressed more than in the first procedure. Further, in the third procedure, the monomer as a raw material of the polymer compound, the solvent, and the like are less likely to be left in the electrolyte layer 36 compared to in the second procedure. Therefore, the formation step of the polymer compound is favorably controlled. Therefore, sufficient adhesion characteristics are obtained between the cathode 33, the anode 34, and the separator 35, and the electrolyte layer 36.

[Function and Effect of Secondary Battery]

According to the laminated-film-type secondary battery, since the cathode active material layer 33B of the cathode 33 contains the foregoing secondary battery-use active material as a cathode active material. Therefore, superior battery characteristics are achievable for a reason similar to that of the cylindrical-type secondary battery. Other functions and other effects are similar to those of the cylindrical-type secondary battery.

[2-3. Secondary Battery-use Electrode and Secondary Battery (Lithium Metal Secondary Battery)]

A secondary battery described here is a lithium secondary battery (lithium metal secondary battery) in which the capacity of the anode 22 is obtained by precipitation and dissolution of lithium metal. The secondary battery has a configuration similar to that of the foregoing cylindrical-type lithium ion secondary battery, except that the anode active material layer 22B is formed of the lithium metal, and is manufactured by a procedure similar to that of the cylindrical-type lithium ion secondary battery.

In the secondary battery, the lithium metal is used as an anode active material, and thereby, high energy density is obtainable. The anode active material layer 22B may exist at the time of assembling, or the anode active material layer 22B does not necessarily exist at the time of assembling and may be formed of the lithium metal precipitated at the time of charge. Further, the anode active material layer 22B may be used as a current collector, and thereby, the anode current collector 22A may be omitted.

The secondary battery may operate, for example, as follows. At the time of charge, lithium ions are discharged from the cathode 21, and are precipitated as the lithium metal on the surface of the anode current collector 22A through the electrolytic solution. In contrast, at the time of discharge, the lithium metal is eluded as lithium ions from the anode active material layer 22B, and is inserted in the cathode 21 through the electrolytic solution.

According to the lithium metal secondary battery, since the cathode active material layer 21B of the cathode 21 contains the foregoing secondary battery-use active material as a cathode active material, superior battery characteristics are obtainable for a reason similar to that of the lithium ion secondary battery. Other functions and other effects are similar to those of the lithium ion secondary battery. It is to be noted that the secondary battery described here is not limited to the cylindrical-type secondary battery, and may be a laminated-film-type secondary battery.

[3. Applications of Secondary Battery]

Next, a description will be given of application examples of the foregoing secondary battery.

Applications of the secondary battery are not particularly limited as long as the secondary battery is applied to a machine, a device, an instrument, an apparatus, a system (collective entity of a plurality of devices and the like), or the like that is allowed to use the secondary battery as a driving electric power source, an electric power storage source for electric power storage, or the like. The secondary battery used as an electric power source may be a main electric power source (electric power source used preferentially), or may be an auxiliary electric power source (electric power source used instead of a main electric power source or used being switched from the main electric power source). In the case where the secondary batter is utilized as an auxiliary electric power source, the main electric power source type is not limited to the secondary battery.

Examples of applications of the secondary battery may include electronic apparatuses (including portable electronic apparatuses) such as a video camcorder, a digital still camera, a mobile phone, a notebook personal computer, a cordless phone, a headphone stereo, a portable radio, a portable television, and a personal digital assistant. Further examples thereof may include a mobile lifestyle electric appliance such as an electric shaver; a memory device such as a backup electric power source and a memory card; an electric power tool such as an electric drill and an electric saw; a battery pack used as a removable and replaceable electric power source of a notebook personal computer or the like; a medical electronic apparatus such as a pacemaker and a hearing aid; an electric vehicle such as an electric automobile (including a hybrid automobile); and an electric power storage system such as a home battery system for storing electric power for emergency or the like. It goes without saying that an application other than the foregoing applications may be adopted.

In particular, the secondary battery is effectively applicable to the battery pack, the electric vehicle, the electric power storage system, the electric power tool, the electronic apparatus, or the like. One reason for this is that, in these applications, since superior battery characteristics are demanded, performance is effectively improved with the use of the secondary battery according to the embodiment of the present application. It is to be noted that the battery pack is an electric power source using a secondary battery, and is a so-called assembled battery or the like. The electric vehicle is a vehicle that works (runs) with the use of a secondary battery as a driving electric power source. As described above, the electric vehicle may be an automobile (such as a hybrid automobile) including a drive source other than a secondary battery. The electric power storage system is a system using a secondary battery as an electric power storage source. For example, in a home electric power storage system, electric power is stored in the secondary battery as an electric power storage source, and therefore, home electric products and the like become usable with the use of the electric power. The electric power tool is a tool in which a movable section (such as a drill) is moved with the use of a secondary battery as a driving electric power source. The electronic apparatus is an apparatus executing various functions with the use of a secondary battery as a driving electric power source (electric power supply source).

A description will be specifically given of some application examples of the secondary battery. It is to be noted that the configurations of the respective application examples explained below are merely examples, and may be changed as appropriate.

[3-1. Battery Pack]

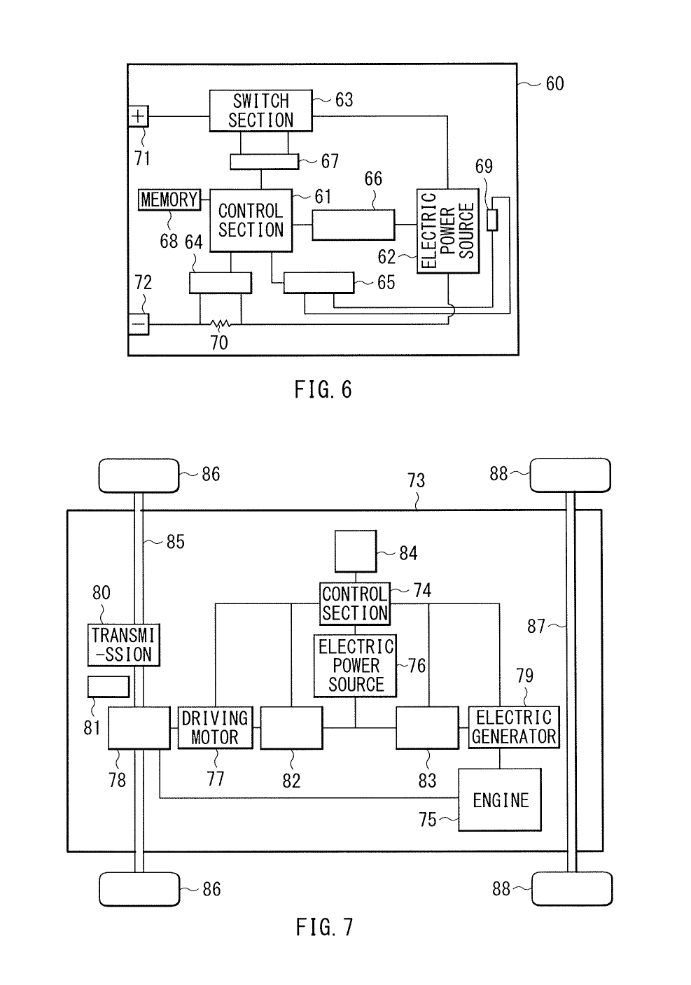

FIG. 6 illustrates a block configuration of a battery pack. For example, the battery pack may include a control section 61, an electric power source 62, a switch section 63, a current measurement section 64, a temperature detection section 65, a voltage detection section 66, a switch control section 67, a memory 68, a temperature detection element 69, a current detection resistance 70, a cathode terminal 71, and an anode terminal 72 in a housing 60 made of a plastic material and/or the like.

The control section 61 controls operation of the whole battery pack (including a used state of the electric power source 62), and may include, for example, a central processing unit (CPU) and/or the like. The electric power source 62 includes one or more secondary batteries (not illustrated). The electric power source 62 may be, for example, an assembled battery including two or more secondary batteries. Connection type of the secondary batteries may be a series-connected type, may be a parallel-connected type, or may be a mixed type thereof. As an example, the electric power source 62 may include six secondary batteries connected in a manner of dual-parallel and three-series.

The switch section 63 switches the used state of the electric power source 62 (whether or not the electric power source 62 is connectable to an external device) according to an instruction of the control section 61. The switch section 63 may include, for example, a charge control switch, a discharge control switch, a charging diode, a discharging diode, and the like (not illustrated). The charge control switch and the discharge control switch may each be, for example, a semiconductor switch such as a field-effect transistor (MOSFET) using a metal oxide semiconductor.

The current measurement section 64 measures a current with the use of the current detection resistance 70, and outputs the measurement result to the control section 61. The temperature detection section 65 measures temperature with the use of the temperature detection element 69, and outputs the measurement result to the control section 61. The temperature measurement result may be used for, for example, a case in which the control section 61 controls charge and discharge at the time of abnormal heat generation or a case in which the control section 61 performs a correction processing at the time of calculating a remaining capacity. The voltage detection section 66 measures a voltage of the secondary battery in the electric power source 62, performs analog-to-digital conversion on the measured voltage, and supplies the resultant to the control section 61.

The switch control section 67 controls operations of the switch section 63 according to signals inputted from the current measurement section 64 and the voltage detection section 66.

The switch control section 67 executes control so that a charging current is prevented from flowing in a current path of the electric power source 62 by disconnecting the switch section 63 (charge control switch) in the case where, for example, a battery voltage reaches an overcharge detection voltage. As a result, in the electric power source 62, only discharge is allowed to be performed through the discharging diode. It is to be noted that, for example, in the case where a large current flows at the time of charge, the switch control section 67 blocks the charging current.

Further, the switch control section 67 executes control so that a discharging current is prevented from flowing in the current path of the electric power source 62 by disconnecting the switch section 63 (discharge control switch) in the case where, for example, a battery voltage reaches an overdischarge detection voltage. As a result, in the electric power source 62, only charge is allowed to be performed through the charging diode. For example, in the case where a large current flows at the time of discharge, the switch control section 67 blocks the discharging current.

It is to be noted that, in the secondary battery, for example, the overcharge detection voltage may be 4.2 V±0.05 V, and the overdischarge detection voltage may be 2.4 V±0.1 V.

The memory 68 may be, for example, an EEPROM as a nonvolatile memory, or the like. The memory 68 may hold, for example, numerical values calculated by the control section 61 and information of the secondary battery measured in a manufacturing step (such as an internal resistance in the initial state). It is to be noted that, in the case where the memory 68 holds a full charge capacity of the secondary battery, the control section 61 is allowed to comprehend information such as a remaining capacity.

The temperature detection element 69 measures temperature of the electric power source 62, and outputs the measurement result to the control section 61. The temperature detection element 69 may be, for example, a thermistor or the like.

The cathode terminal 71 and the anode terminal 72 are terminals connected to an external device (such as a notebook personal computer) driven with the use of the battery pack or an external device (such as a battery charger) used for charging the battery pack. The electric power source 62 is charged and discharged through the cathode terminal 71 and the anode terminal 72.

[3-2. Electric Vehicle]

FIG. 7 illustrates a block configuration of a hybrid automobile as an example of electric vehicles. For example, the electric vehicle may include a control section 74, an engine 75, an electric power source 76, a driving motor 77, a differential 78, an electric power generator 79, a transmission 80, a clutch 81, inverters 82 and 83, and various sensors 84 in a housing 73 made of metal. In addition thereto, the electric vehicle may include, for example, a front drive shaft 85 and front tires 86 that are connected to the differential 78 and the transmission 80, a rear drive shaft 87, and rear tires 88.

The electric vehicle may run with the use of, for example, one of the engine 75 and the motor 77 as a drive source. The engine 75 is a main power source, and may be, for example, a petrol engine. In the case where the engine 75 is used as a power source, drive power (torque) of the engine 75 may be transferred to the front tires 86 or the rear tires 88 through the differential 78, the transmission 80, and the clutch 81 as drive sections, for example. The torque of the engine 75 may also be transferred to the electric power generator 79. With the use of the torque, the electric power generator 79 generates alternating-current electric power. The alternating-current electric power is converted into direct-current electric power through the inverter 83, and the converted power is stored in the electric power source 76. In contrast, in the case where the motor 77 as a conversion section is used as a power source, electric power (direct-current electric power) supplied from the electric power source 76 is converted into alternating-current electric power through the inverter 82. The motor 77 is driven with the use of the alternating-current electric power. Drive power (torque) obtained by converting the electric power by the motor 77 may be transferred to the front tires 86 or the rear tires 88 through the differential 78, the transmission 80, and the clutch 81 as the drive sections, for example.

It is to be noted that, alternatively, the following mechanism may be adopted. In the mechanism, when speed of the electric vehicle is reduced by an unillustrated brake mechanism, the resistance at the time of speed reduction is transferred to the motor 77 as torque, and the motor 77 generates alternating-current electric power by the torque. It may be preferable that the alternating-current electric power be converted to direct-current electric power through the inverter 82, and the direct-current regenerative electric power be stored in the electric power source 76.

The control section 74 controls operations of the whole electric vehicle, and, for example, may include a CPU and/or the like. The electric power source 76 includes one or more secondary batteries (not illustrated). Alternatively, the electric power source 76 may be connected to an external electric power source, and electric power may be stored by receiving the electric power from the external electric power source. The various sensors 84 may be used, for example, for controlling the number of revolutions of the engine 75 or for controlling opening level (throttle opening level) of an unillustrated throttle valve. The various sensors 84 may include, for example, a speed sensor, an acceleration sensor, an engine frequency sensor, and/or the like.

The description has been given above of the hybrid automobile as an electric vehicle. However, examples of the electric vehicles may include a vehicle (electric automobile) working with the use of only the electric power source 76 and the motor 77 without using the engine 75.

[3-3. Electric Power Storage System]

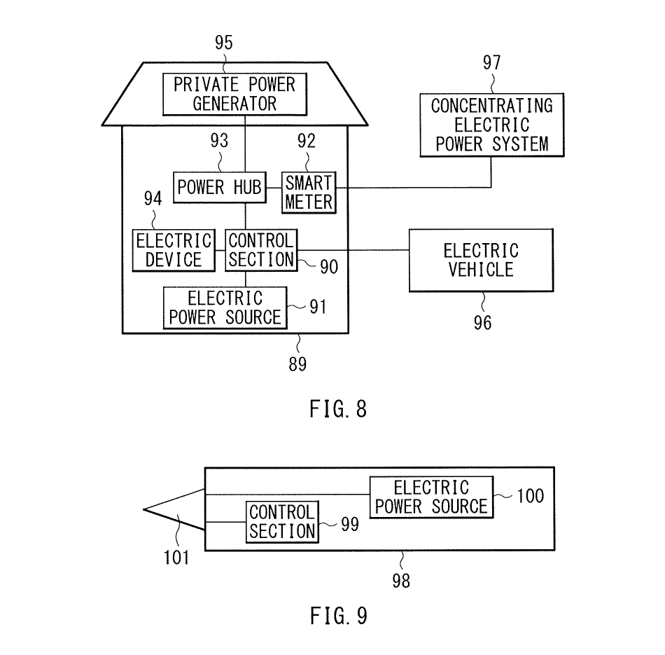

FIG. 8 illustrates a block configuration of an electric power storage system. For example, the electric power storage system may include a control section 90, an electric power source 91, a smart meter 92, and a power hub 93 inside a house 89 such as a general residence and a commercial building.

In this case, the electric power source 91 may be connected to, for example, an electric device 94 arranged inside the house 89, and may be connectable to an electric vehicle 96 parked outside the house 89. Further, for example, the electric power source 91 may be connected to a private power generator 95 arranged inside the house 89 through the power hub 93, and may be connectable to an external concentrating electric power system 97 through the smart meter 92 and the power hub 93.

It is to be noted that the electric device 94 may include, for example, one or more home electric appliances such as a refrigerator, an air conditioner, a television, and a water heater. The private power generator 95 may be, for example, one or more of a solar power generator, a wind-power generator, and the like. The electric vehicle 96 may be, for example, one or more of an electric automobile, an electric motorcycle, a hybrid automobile, and the like. The concentrating electric power system 97 may be, for example, one or more of a thermal power plant, an atomic power plant, a hydraulic power plant, a wind-power plant, and the like.

The control section 90 controls operation of the whole electric power storage system (including a used state of the electric power source 91), and, for example, may include a CPU and/or the like. The electric power source 91 includes one or more secondary batteries (not illustrated). The smart meter 92 may be, for example, an electric power meter compatible with a network arranged in the house 89 demanding electric power, and may be communicable with an electric power supplier. Accordingly, for example, while the smart meter 92 communicates with outside, the smart meter 92 controls the balance between supply and demand in the house 89, and thereby, allows effective and stable energy supply.

In the electric power storage system, for example, electric power may be stored in the electric power source 91 from the concentrating electric power system 97 as an external electric power source through the smart meter 92 and the power hub 93, and electric power is stored in the electric power source 91 from the private power generator 95 as an independent electric power source through the power hub 93. The electric power stored in the electric power source 91 is supplied to the electric device 94 or to the electric vehicle 96 according to an instruction of the control section 90. Therefore, the electric device 94 becomes operable, and the electric vehicle 96 becomes chargeable. In other words, the electric power storage system is a system capable of storing and supplying electric power in the house 89 with the use of the electric power source 91.

The electric power stored in the electric power source 91 is arbitrarily usable. Therefore, for example, electric power is allowed to be stored in the electric power source 91 from the concentrating electric power system 97 in the middle of the night when an electric rate is inexpensive, and the electric power stored in the electric power source 91 is allowed to be used during daytime hours when an electric rate is expensive.

It is to be noted that the foregoing electric power storage system may be arranged for each household (family unit), or may be arranged for a plurality of households (family units).

[3-4. Electric Power Tool]

FIG. 9 illustrates a block configuration of an electric power tool. For example, the electric power tool may be an electric drill, and may include a control section 99 and an electric power source 100 in a tool body 98 made of a plastic material and/or the like. For example, a drill section 101 as a movable section may be attached to the tool body 98 in an operable (rotatable) manner.

The control section 99 controls operations of the whole electric power tool (including a used state of the electric power source 100), and may include, for example, a CPU and/or the like. The electric power source 100 includes one or more secondary batteries (not illustrated). The control section 99 allows electric power to be supplied from the electric power source 100 to the drill section 101 according to operation of an unillustrated operation switch to operate the drill section 101.

### EXAMPLES

Specific examples of the embodiment of the present application will be described in detail.

### Examples 1 to 22

### Synthesis of Cathode Active Material

First, a lithium-containing compound particle (Li₁₊ₐ(Mn_{b}Co_{c}Ni_{1-b-c})₁₋ₐM_{d}O₂₋ₑ) used as a cathode active material was obtained by the following procedure.

First, lithium carbonate (Li₂CO₃), manganese carbonate (MnCO₃), nickel hydroxide (Ni(OH)₂), cobalt hydroxide (Co(OH)₂), and aluminum nitrate enneahydrate (Al(NO₃)₃.9H₂O) as raw materials were prepared. Subsequently, the raw materials were mixed, and thereafter, was sufficiently mixed and pulverized by a ball mill with the use of water as a dispersion medium. In this case, the mixture ratio of the raw materials was adjusted so that the compositions (molar ratios) of a composite oxide to be obtained became Li:Mn:Co:Ni:Al=1.13:0.522:0.174:0.174:0.01. Subsequently, the mixture was fired in the air (at 850 deg C. for 12 hours) to synthesize the composite oxide (Li_{1.13}(Mn_{0.6}Co_{0.2}Ni_{0.2})_{0.87}Al_{0.01}O₂). Subsequently, the composite oxide was soaked into a diammonium hydrogen phosphate ((NH₄)₂HPO₄) solution (1 mol %) as a treatment liquid (for one hour), which was subsequently stirred (500 rpm), and thereafter, moisture was vaporized. By such surface treatment with the use of the treatment liquid, the molar ratio Mn became gradually larger as a location was shifted from the central section of the composite oxide toward the surface section thereof, and the molar ratio Li became gradually smaller as a location was shifted from the central section of the composite oxide toward the surface thereof. Finally, the composite oxide was fired again (at 300 deg C. for 10 hours).

In addition thereto, lithium-containing compound particles illustrated in Table 1 and Table 2 were obtained by changing the foregoing conditions such as the raw materials types and the mixture ratio. Specific contents of conditions obtained by such change here were as follows.

In order to change the M type and presence or absence thereof, Al(NO₃)₃.9H₂O was not used as a raw material, and magnesium carbonate (MgCO₃) was used as other raw material. In particular, in the case where M was Ti, a composite oxide was synthesized without using Al(NO₃)₃.9H₂O, and thereafter, the composite oxide was treated (for one hour) together with titanium oxide (TiO₂) with the use of a mechanochemical apparatus. In order to change the values a to d, a mixture ratio of raw materials was adjusted. In order to change the value e, a composite oxide was synthesized while firing treatment was performed in nitrogen (N₂) atmosphere instead of air, or while nitrogen bubbling was performed, and thereafter, firing treatment was performed in N₂ atmosphere. In order to change the ratio 1+a1/1+a2, a mixture ratio of raw materials was adjusted, or firing treatment was performed in N₂ atmosphere, or nitric acid (HNO₃: 0.5 mol % to 1.5 mol % both inclusive) was used instead of the (NH₄)₂HPO₄ solution. In particular, the HNO₃ concentration was set to a high value (1.5 mol %) in the case where the ratio 1+a1/1+a2 was largely decreased, and the HNO₃ concentration was set to a low value (0.5 mol %) in the case where the ratio 1+a1/1+a2 was largely increased.

Compositions of the respective lithium-containing compound particles (the molar ratios a to e and the ratios 1+a1/1+a2 and b1/b2) are as illustrated in Table 1 and Table 2. “Slope of Mn molar ratio” refers to whether or not the Mn molar ratio is increased as a location is shifted from the central section of each of the lithium-containing compound particles toward the surface section thereof. “Slope of Li molar ratio” refers to whether or not the Li molar ratio is decreased as a location is shifted from the central section of each of the lithium-containing compound particles toward the surface section thereof.

Each molar ratio in the surface section was examined as follows. First, inside of each of the lithium-containing compound particles was infiltrated with a resin, the resultant was dried in vacuum, and thereafter, each of the lithium-containing compound particles was subjected to focused ion beam (FIB) process to expose a cross section. Subsequently, while each of the lithium-containing compound particles was cooled with the use of liquid nitrogen, each of the lithium-containing compound particles was subjected to an argon (Ar) ion milling process with the use of a no damage electron microscope prototype thinning apparatus (Model 1040 available from Fischione Instruments, Inc) to fabricate a measurement sample. Finally, each composition of each of the lithium-containing compound particles was analyzed with the use of an electron microscope (JEM 2100F with an accelerating voltage of 200 kV available from JEOL Ltd.) and an accompanying EDX analyzer.

Each molar ratio in the central section was examined as follows. Each average composition of each of the lithium-containing compound particles was analyzed with the use of a scanning X-ray photoelectron spectrometer (Quantera SXM, available from ULVAC-PHI, INCORPORATED). In this case, monochromatic Al—Kα (1486.6 eV) was used as an X-ray source (X-ray spot diameter: 100 μm), and 1 kV, 1 mm×1 mm, and about 7.7 nm/min were used as Ar sputtering conditions.

Presence or absence of “slope of Mn molar ratio” and “slope of Li molar ratio” was examined as follows. While each of the lithium-containing compound particles was dissolved with the use of weak acid, compositions (each of the Mn molar ratios and each of the Li molar ratios) were examined every one minute, and a plot was built. From the results thereof, a case that a molar ratio was changed was rated as “present,” and a case that a molar ratio was not changed was rated as “absent.”

[Fabrication of Secondary Battery]

The laminated-film-type lithium ion secondary battery illustrated in FIG. 4 and FIG. 5 was fabricated with the use of the foregoing cathode active material.

In fabricating the cathode 33, 90 parts by mass of a cathode active material, 5 parts by mass of a cathode binder (polyvinylidene fluoride (PVDF)), and 5 parts by mass of a cathode electric conductor (Ketjen black) were mixed to obtain a cathode mixture. Subsequently, the cathode mixture was dispersed in an organic solvent (N-methyl-2-pyrrolidone (NMP)) to obtain cathode mixture slurry. Subsequently, both surfaces of the cathode current collector 33A (an aluminum foil having a thickness of 15 μm) were coated with the cathode mixture slurry uniformly, which was dried by hot air to form the cathode active material layer 33B. Finally, the cathode active material layer 33B was compression-molded with the use of a roll pressing machine. Thereafter, the cathode current collector 33A and the cathode active material layer 33B were cut in the shape of a strip (48 mm×300 mm).

In fabricating of the anode 34, each of the anode active materials illustrated in Table 1 and Table 2 and 20 wt % NMP solution of polyimide were mixed at a mass ratio of 7:2 to obtain anode mixture slurry. As the anode active materials, silicon oxide (SiO: median diameter=7 μm), silicon (Si: median diameter=7 μm), and graphite (C: median diameter=15 μm) were used. Subsequently, both surfaces of the anode current collector 34A (a copper foil having a thickness of 15 μm) were coated with the anode mixture slurry uniformly, and thereafter, the resultant coating film thereof was dried (80 deg C.). Subsequently, the coating film was compression-molded with the use of a roll pressing machine. Thereafter, the coating film was heated (at 700 deg C. for 3 hours) to form the anode active material layer 34B. Finally, the anode current collector 34A and the anode active material layer 34B were cut in the shape of a strip (50 mm×310 mm).

The secondary battery was assembled as follows. The cathode lead 25 made of aluminum was welded to the cathode current collector 33A of the cathode 33, and the anode lead 26 made of copper was welded to the anode current collector 34A of the anode 34. Subsequently, the cathode 33 and the anode 34 were laminated with the separator 35 (microporous polyethylene film having a thickness of 25 μm) in between, and the resultant laminated body was spirally wound in the longitudinal direction to fabricate the spirally wound electrode body 30. Thereafter, the protective tape 37 was adhered to the outermost peripheral section of the spirally wound electrode body 30. Subsequently, the spirally wound electrode body 30 was arranged between two film-like outer package members 40. Thereafter, the outermost peripheries on three sides of the outer package members 40 were thermally fusion-bonded to obtain a pouch-like shape. The outer package member 40 was a moisture-resistant aluminum laminated film in which a nylon film having a thickness of 25 μm, an aluminum foil having a thickness of 40 μm, and a polypropylene film having a thickness of 30 μm were laminated from outside. Finally, an electrolytic solution was injected into the outer package members 40, and the separator 35 was impregnated with the electrolytic solution. Thereafter, each of the remaining one side of the outer package members 40 was thermally fusion-bonded to each other in reduced-pressure environment. The electrolytic solution was obtained by dissolving an electrolyte salt (LiPF₆) in a solvent (ethylene carbonate (EC) and ethylmethyl carbonate (EMC)). The composition (mass ratio) of the solvent was EC:EMC=50:50, and the content of the electrolyte salt with respect to the solvent was 1 mol/dm³ (=1 mol/l).

[Measurement of Battery Characteristics]

As battery characteristics of the secondary battery, capacity characteristics, cycle characteristics, swelling characteristics, and conservation characteristics were examined. Results illustrated in Table 1 and Table 2 were obtained.

Upon examining the capacity characteristics and the cycle characteristics, the initial capacity (mAh) and the cycle retention ratio (%) were obtained by the following procedure. The secondary battery was charged and discharged two cycles in the ambient temperature environment (23 deg C.) to measure a discharge capacity (mAh) at the second cycle as the initial capacity. Subsequently, the secondary battery was repeatedly charged and discharged until the total number of cycles reached 300 in the same environment, and a discharge capacity (mAh) at the 300th cycle was measured. Finally, cycle retention ratio (%)=(discharge capacity at the 300th cycle/discharge capacity at the second cycle)×100 was calculated. As charge and discharge conditions, the charging current was 1.5 A, the charging voltage was 4.55 V, the charging time was 2.5 hours, the discharging current was 0.5 A, and the final voltage was 3 V.

Upon examining the swelling characteristics, after the thickness (mm) of the secondary battery before charge and discharge was measured in the ambient temperature environment (23 deg C.), the secondary battery was charged and discharged two cycles, and thereafter, the thickness (mm) after charge and discharge was measured. From the measurement result thereof, swelling (mm)=thickness after charge and discharge-thickness before charge and discharge was calculated. The charge and discharge conditions were similar to those in the case of examining the capacity characteristics.

Upon examining the conservation characteristics, the secondary battery was charged and discharged in the ambient temperature environment (23 deg C.) to measure a discharge capacity (mAh) before conservation. Subsequently, the secondary battery was charged again, and the secondary battery was conserved for 300 hours in high temperature environment (60 deg C.). Thereafter, the secondary battery was discharged to measure a discharge capacity (mAh) after conservation. From the result, conservation retention ratio (%)=(discharge capacity after conservation/discharge capacity before conservation)×100 was calculated. As charge and discharge conditions, the charging current was 0.5 A, the charging voltage was 4.55 V, the charging time was 2.5 hours, the discharging current was 0.5 A, and the final voltage was 3 V.

TABLE 1

| | Lithium-containing compound particle | | | | | | | | | | | | | | |
|---|---|---|---|---|---|---|---|---|---|---|---|---|---|---|---|
| | (Li₁₊ₐ (Mn_{b} Co_{c} Ni_{1-b-c})₁₋ₐM_{d} O₂₋ₑ) | | | | | | | | | | | | | | |
| | | | | | | | Slope of | Slope | | | | | Cycle | | Conservation |
| | | | | | | | Mn | of Li | | | Anode | Initial | retention | | retention |
| | | | | | | | molar | molar | 1 + a1/ | b1/ | active | capacity | ratio | Swelling | ratio |
| Example | a | b | c | d | e | M | ratio | ratio | 1 + a2 | b2 | material | (mAh) | (%) | (mm) | (%) |
| 1 | 0.13 | 0.6 | 0.2 | 0.01 | 0 | Al | Present | Present | 0.88 | 1.21 | SiO | 915 | 89 | 8.95 | 92 |
| 2 | 0.13 | 0.6 | 0.2 | 0.01 | 0.2 | Al | Present | Present | 0.81 | 1.22 | SiO | 878 | 87 | 8.88 | 88 |
| 3 | 0.05 | 0.6 | 0.2 | 0.01 | 0 | Al | Present | Present | 0.86 | 1.18 | SiO | 889 | 88 | 8.77 | 89 |
| 4 | 0.13 | 0.5 | 0.2 | 0.01 | 0 | Al | Present | Present | 0.87 | 1.36 | SiO | 871 | 89 | 8.97 | 89 |
| 5 | 0.13 | 0.6 | 0.1 | 0.01 | 0 | Al | Present | Present | 0.88 | 1.23 | SiO | 905 | 87 | 9.03 | 89 |
| 6 | 0.13 | 0.6 | 0.2 | 1 | 0 | Al | Present | Present | 0.88 | 1.3 | SiO | 879 | 90 | 8.99 | 91 |
| 7 | 0.13 | 0.6 | 0.2 | 0.01 | 0 | Al | Present | Present | 0.52 | 1.15 | SiO | 851 | 86 | 8.61 | 87 |
| 8 | 0.13 | 0.6 | 0.2 | 0.01 | 0 | Al | Present | Present | 0.58 | 1.14 | SiO | 863 | 88 | 8.56 | 89 |
| 9 | 0.13 | 0.6 | 0.2 | 0.01 | 0 | Al | Present | Present | 0.97 | 1.32 | SiO | 903 | 87 | 9.18 | 89 |
| 10 | 0.13 | 0.6 | 0.2 | 0.01 | 0 | Mg | Present | Present | 0.88 | 1.31 | SiO | 910 | 89 | 9.02 | 90 |
| 11 | 0.13 | 0.6 | 0.2 | 0.01 | 0 | Ti | Present | Present | 0.87 | 1.32 | SiO | 911 | 89 | 8.83 | 88 |
| 12 | 0.2 | 0.6 | 0.2 | 0 | 0 | — | Present | Present | 0.88 | 1.35 | SiO | 920 | 87 | 9.23 | 87 |
| 13 | 0.13 | 0.6 | 0.2 | 0.01 | 0 | Al | Present | Present | 0.88 | 1.21 | Si | 883 | 89 | 9.01 | 90 |
| 14 | 0.13 | 0.6 | 0.2 | 0.01 | 0 | Al | Present | Present | 0.88 | 1.21 | C | 809 | 88 | 8.89 | 89 |

TABLE 2

| | Lithium-containing compound particle | | | | | | | | | | | | | | |
|---|---|---|---|---|---|---|---|---|---|---|---|---|---|---|---|
| | (Li₁₊ₐ (Mn_{b} Co_{c} Ni_{1-b-c})₁₋ₐM_{d} O₂₋ₑ) | | | | | | | | | | | | | | |
| | | | | | | | Slope of | Slope | | | | | Cycle | | Conservation |
| | | | | | | | Mn | of Li | | | Anode | Initial | retention | | retention |
| | | | | | | | molar | molar | 1 + a1/ | b1/ | active | capacity | ratio | Swelling | ratio |
| Example | a | b | c | d | e | M | ratio | ratio | 1 + a2 | b2 | material | (mAh) | (%) | (mm) | (%) |
| 15 | 0.13 | 0.6 | 0.2 | 0 | 0 | — | Absent | Absent | 1 | 1 | SiO | 921 | 71 | 18.6 | 66 |
| 16 | 0.13 | 0.6 | 0.2 | 0.01 | 0 | Al | Absent | Absent | 1 | 1 | SiO | 919 | 78 | 18.2 | 74 |
| 17 | 0.3 | 0.6 | 0.2 | 0.01 | 0 | Al | Present | Absent | 1 | 1.22 | SiO | 866 | 80 | 9.79 | 81 |
| 18 | 0.13 | 0.4 | 0.2 | 0.01 | 0 | Al | Present | Present | 0.88 | 1.2 | SiO | 774 | 84 | 9.21 | 88 |
| 19 | 0.13 | 0.6 | 0.2 | 1.5 | 0 | Al | Present | Present | 0.9 | 1.44 | SiO | 764 | 74 | 9.34 | 85 |
| 20 | 0.13 | 0.6 | 0.2 | 0.01 | 1.1 | Al | Present | Present | 0.89 | 1.21 | SiO | 791 | 59 | 10.1 | 71 |
| 21 | 0.13 | 0.6 | 0.2 | 0.01 | 0 | Al | Present | Present | 0.48 | 1.42 | SiO | 784 | 81 | 8.53 | 84 |
| 22 | 0.13 | 0.6 | 0.2 | 0.01 | 0 | Mg | Present | Present | 0.49 | 1.45 | SiO | 791 | 80 | 8.55 | 85 |

The battery characteristics largely varied according to the compositions and the configurations of the lithium-containing compound particles (Li₁₊ₐ(Mn_{b}Co_{c}Ni_{1-b-c})₁₋ₐM_{d}O₂₋ₑ).

More specifically, in the case where a to e satisfied conditions of 0<a<0.25, 0.5≦b<0.7, 0≦c<1−b, 0≦d≦1, and 0≦e≦1, the initial capacity, the cycle retention ratio, and the conservation retention ratio were increased compared to a case in which the foregoing conditions were not satisfied.

Further, in the case where both the molar ratio of Mn and the molar ratio of Li were sloped, the cycle retention ratio and the conservation retention ratio were increased, and the swelling was decreased, compared to a case in which both the molar ratios were not sloped.

Further, in the case where the ratio 1+a1/1+a2 satisfied 0.5<1+a1/1+a2<1, while the initial capacity was substantially retained, the cycle retention ratio and the conservation retention ratio were increased, and the swelling was decreased, compared to a case in which the ratio 1+a1/1+a2 did not satisfy 0.5<1+a1/1+a2<1.

From the results of Table 1 and Table 2, in the case where the lithium-containing compound particle as a cathode active material had the composition represented by Formula (1); and the molar ratios b1 and b2 of Mn, the molar ratios 1+a1 and 1+a2 of Li, and the ratio 1+a1/1+a2 satisfied the foregoing conditions respectively, superior battery characteristics were obtained.

The present application has been described above referring to the preferred embodiment and Examples. However, the present application is not limited to the examples described in the preferred embodiment and Examples, and may be variously modified. For example, the description has been given with the specific examples of the case in which the battery structure is the cylindrical type or the laminated film type, and the battery device has the spirally wound structure. However, applicable structures are not limited thereto. The secondary battery of the present application is similarly applicable to a battery having other battery structure such as a square-type battery, a coin-type battery, and a button-type battery, or a battery in which the battery device has other structure such as a laminated structure.

Further, the secondary battery-use active material and the secondary battery-use electrode of the present application may be applied not only to a secondary battery, but also to other electrochemical devices. Examples of other electrochemical devices may include a capacitor.

Further, the description has been given of the appropriate ranges derived from the results of Examples for a range of ratio 1+a1/1+a2. However, the description does not totally deny a possibility that the ratio 1+a1/1+a2 becomes out of the foregoing range. In other words, the foregoing appropriate range is a particularly preferable range to obtain the effect of the present application. Therefore, as long as the effect of the present application is obtainable, the ratio 1+a1/1+a2 may be out of the foregoing range in some degree. The same is applicable to ranges of a to e and the like shown in Formula (1).

It is to be noted that the present application may be configured as follows.

(1) A secondary battery including:

a cathode;

an anode; and

an electrolytic solution, wherein

the cathode includes a lithium-containing compound, the lithium-containing compound having an average composition represented by a following Formula (1),

the lithium-containing compound includes a central section and a surface section,

a molar ratio b1 of manganese (Mn) in the surface section is larger than a molar ratio b2 of Mn in the central section,

a molar ratio 1+a1 of lithium (Li) in the surface section is smaller than a molar ratio 1+a2 of Li in the central section, and

a ratio 1+a1/1+a2 between the molar ratio 1+a1 of Li in the surface section and the molar ratio 1+a2 of Li in the central section satisfies 0.5<1+a1/1+a2<1,

Li₁₊ₐ(Mn_{b}Co_{c}Ni_{1-b-c})₁₋ₐM_{d}O₂₋ₑ (1)

where M is one or more of aluminum (Al), magnesium (Mg), zirconium (Zr), titanium (Ti), barium (Ba), boron (B), silicon (Si), and iron (Fe); and a to e satisfy 0<a<0.25, 0.5≦b<0.7, 0≦c<1−b, 0≦d≦1, and 0≦e≦1.
(2) The secondary battery according to (1), wherein the M in the Formula (1) is one or more of Al, Mg, and Ti.
(3) The secondary battery according to (1) or (2), wherein the a in the Formula (1) satisfies 0.1<a<0.25.
(4) The secondary battery according to any one of (1) to (3), wherein

the anode contains a metal-based material, and

the metal-based material includes Si or tin (Sn) or both as constituent elements.

(5) The secondary battery according to (4), wherein the metal-based material includes a silicon oxide represented by SiOᵥ (0.2<v<1.4).
(6) The secondary battery according to any one of (1) to (5), wherein charge is performed until a voltage reaches a value equal to or larger than about 4.4 V (to lithium metal).
(7) The secondary battery according to any one of (1) to (6), wherein the secondary battery is a lithium secondary battery.
(8) A secondary battery-use electrode, the secondary battery-use electrode including a lithium-containing compound, the lithium-containing compound having an average composition represented by a following Formula (1), wherein

the lithium-containing compound includes a central section and a surface section,

a molar ratio b1 of Mn in the surface section is larger than a molar ratio b2 of Mn in the central section,

a molar ratio 1+a1 of Li in the surface section is smaller than a molar ratio 1+a2 of Li in the central section, and

a ratio 1+a1/1+a2 between the molar ratio 1+a1 of Li in the surface section and the molar ratio 1+a2 of Li in the central section satisfies 0.5<1+a1/1+a2<1,

Li₁₊ₐ(Mn_{b}Co_{c}Ni_{1-b-c})₁₋ₐM_{d}O₂₋ₑ (1)

where M is one or more of Al, Mg, Zr, Ti, Ba, B, Si, and Fe; and a to e satisfy 0<a<0.25, 0.5≦b<0.7, 0≦c<1−b, 0≦d≦1, and 0≦e≦1.
(9) A secondary battery-use active material, the secondary battery-use active material including a lithium-containing compound, the lithium-containing compound having an average composition represented by a following Formula (1), wherein

the lithium-containing compound includes a central section and a surface section,

a molar ratio b1 of Mn in the surface section is larger than a molar ratio b2 of Mn in the central section,

a molar ratio 1+a1 of Li in the surface section is smaller than a molar ratio 1+a2 of Li in the central section, and

a ratio 1+a1/1+a2 between the molar ratio 1+a1 of Li in the surface section and the molar ratio 1+a2 of Li in the central section satisfies 0.5<1+a1/1+a2<1,

Li₁₊ₐ(Mn_{b}Co_{c}Ni_{1-b-c})₁₋ₐM_{d}O₂₋ₑ (1)

where M is one or more of Al, Mg, Zr, Ti, Ba, B, Si, and Fe; and a to e satisfy 0<a<0.25, 0.5≦b<0.7, 0≦c<1−b, 0≦d≦1, and 0≦e≦1.
(10) A battery pack including:

the secondary battery according to any one of (1) to (7);

a control section configured to control operation of the secondary battery; and

a switch section configured to switch the operation of the secondary battery according to an instruction of the control section.

(11) An electric vehicle including:

the secondary battery according to any one of (1) to (7);

a conversion section configured to convert electric power supplied from the secondary battery into drive power;

a drive section configured to operate according to the drive power; and

a control section configured to control operation of the secondary battery.

(12) An electric power storage system including:

the secondary battery according to any one of (1) to (7);

one or more electric devices configured to be supplied with electric power from the secondary battery; and

a control section configured to control the supplying of the electric power from the secondary battery to the one or more electric devices.

(13) An electric power tool including:

the secondary battery according to any one of (1) to (7); and

a movable section configured to be supplied with electric power from the secondary battery.

(14) An electronic apparatus including the secondary battery according to any one of (1) to (7) as an electric power supply source.

It should be understood by those skilled in the art that various modifications, combinations, sub-combinations, and alternations may occur depending on design requirements and other factors insofar as they are within the scope of the appended claims or the equivalents thereof.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A secondary battery comprising:
a cathode;
an anode; and
an electrolytic solution, wherein
the cathode includes a lithium-containing compound, the lithium-containing compound having an average composition represented by a following Formula (1),
the lithium-containing compound includes a central section and a surface section,
a molar ratio b1 of manganese (Mn) in the surface section is larger than a molar ratio b2 of Mn in the central section,
a molar ratio 1+a1 of lithium (Li) in the surface section is smaller than a molar ratio 1+a2 of Li in the central section, and
a ratio 1+a1/1+a2 between the molar ratio 1+a1 of Li in the surface section and the molar ratio 1+a2 of Li in the central section satisfies 0.5<1+a1/1+a2<1,
Li₁₊ₐ(Mn_{b}Co_{c}Ni_{1-b-c})₁₋ₐM_{d}O₂₋ₑ (1)
where M is one or more of aluminum (Al), magnesium (Mg), zirconium (Zr), titanium (Ti), barium (Ba), boron (B), silicon (Si), and iron (Fe); and a to e satisfy 0<a<0.25, 0.5≦b<0.7, 0≦c<1−b, 0≦d≦1, and 0≦e≦1.

2. The secondary battery according to claim 1, wherein the M in the Formula (1) is one or more of Al, Mg, and Ti.

3. The secondary battery according to claim 1, wherein the a in the Formula (1) satisfies 0.1<a<0.25.

4. The secondary battery according to claim 1, wherein
the anode contains a metal-based material, and
the metal-based material includes Si or tin (Sn) or both as constituent elements.

5. The secondary battery according to claim 4, wherein the metal-based material includes a silicon oxide represented by SiOᵥ (0.2<v<1.4).

6. The secondary battery according to claim 1, wherein charge is performed until a voltage reaches a value equal to or larger than about 4.4 V (to lithium metal).

7. The secondary battery according to claim 1, wherein the secondary battery is a lithium secondary battery.

8. A secondary battery-use electrode, the secondary battery-use electrode including a lithium-containing compound, the lithium-containing compound having an average composition represented by a following Formula (1), wherein
the lithium-containing compound includes a central section and a surface section,
a molar ratio b1 of Mn in the surface section is larger than a molar ratio b2 of Mn in the central section,
a molar ratio 1+a1 of Li in the surface section is smaller than a molar ratio 1+a2 of Li in the central section, and
a ratio 1+a1/1+a2 between the molar ratio 1+a1 of Li in the surface section and the molar ratio 1+a2 of Li in the central section satisfies 0.5<1+a1/1+a2<1,
Li₁₊ₐ(Mn_{b}Co_{c}Ni_{1-b-c})₁₋ₐM_{d}O₂₋ₑ (1)
where M is one or more of Al, Mg, Zr, Ti, Ba, B, Si, and Fe; and a to e satisfy 0<a<0.25, 0.5≦b<0.7, 0≦c<1−b, 0≦d≦1, and 0≦e≦1.

9. A secondary battery-use active material, the secondary battery-use active material including a lithium-containing compound, the lithium-containing compound having an average composition represented by a following Formula (1), wherein
the lithium-containing compound includes a central section and a surface section,
a molar ratio b1 of Mn in the surface section is larger than a molar ratio b2 of Mn in the central section,
a molar ratio 1+a1 of Li in the surface section is smaller than a molar ratio 1+a2 of Li in the central section, and
a ratio 1+a1/1+a2 between the molar ratio 1+a1 of Li in the surface section and the molar ratio 1+a2 of Li in the central section satisfies 0.5<1+a1/1+a2<1,
Li₁₊ₐ(Mn_{b}Co_{c}Ni_{1-b-c})₁₋ₐM_{d}O₂₋ₑ (1)
where M is one or more of Al, Mg, Zr, Ti, Ba, B, Si, and Fe; and a to e satisfy 0<a<0.25, 0.5≦b<0.7, 0≦c<1−b, 0≦d≦1, and 0≦e≦1.

10. A battery pack comprising:
a secondary battery;
a control section configured to control operation of the secondary battery; and
a switch section configured to switch the operation of the secondary battery according to an instruction of the control section, wherein
the secondary battery includes a cathode, an anode, and an electrolytic solution,
the cathode includes a lithium-containing compound, the lithium-containing compound having an average composition represented by a following Formula (1),
the lithium-containing compound includes a central section and a surface section,
a molar ratio b1 of Mn in the surface section is larger than a molar ratio b2 of Mn in the central section,
a molar ratio 1+a1 of Li in the surface section is smaller than a molar ratio 1+a2 of Li in the central section, and
a ratio 1+a1/1+a2 between the molar ratio 1+a1 of Li in the surface section and the molar ratio 1+a2 of Li in the central section satisfies 0.5<1+a1/1+a2<1,
Li₁₊ₐ(Mn_{b}Co_{c}Ni_{1-b-c})₁₋ₐM_{d}O₂₋ₑ (1)
where M is one or more of Al, Mg, Zr, Ti, Ba, B, Si, and Fe; and a to e satisfy 0<a<0.25, 0.5≦b<0.7, 0≦c<1−b, 0≦d≦1, and 0≦e≦1.

11. An electric vehicle comprising:
a secondary battery;
a conversion section configured to convert electric power supplied from the secondary battery into drive power;
a drive section configured to operate according to the drive power; and
a control section configured to control operation of the secondary battery, wherein
the secondary battery includes a cathode, an anode, and an electrolytic solution,
the cathode includes a lithium-containing compound, the lithium-containing compound having an average composition represented by a following Formula (1),
the lithium-containing compound includes a central section and a surface section,
a molar ratio b1 of Mn in the surface section is larger than a molar ratio b2 of Mn in the central section,
a molar ratio 1+a1 of Li in the surface section is smaller than a molar ratio 1+a2 of Li in the central section, and
a ratio 1+a1/1+a2 between the molar ratio 1+a1 of Li in the surface section and the molar ratio 1+a2 of Li in the central section satisfies 0.5<1+a1/1+a2<1,
Li₁₊ₐ(Mn_{b}Co_{c}Ni_{1-b-c})₁₋ₐM_{d}O₂₋ₑ (1)
where M is one or more of Al, Mg, Zr, Ti, Ba, B, Si, and Fe; and a to e satisfy 0<a<0.25, 0.5≦b<0.7, 0≦c<1−b, 0≦d≦1, and 0≦e≦1.

12. An electric power storage system comprising:
a secondary battery;
one or more electric devices configured to be supplied with electric power from the secondary battery; and
a control section configured to control the supplying of the electric power from the secondary battery to the one or more electric devices, wherein
the secondary battery includes a cathode, an anode, and an electrolytic solution,
the cathode includes a lithium-containing compound, the lithium-containing compound having an average composition represented by a following Formula (1),
the lithium-containing compound includes a central section and a surface section,
a molar ratio b1 of Mn in the surface section is larger than a molar ratio b2 of Mn in the central section,
a molar ratio 1+a1 of Li in the surface section is smaller than a molar ratio 1+a2 of Li in the central section, and
a ratio 1+a1/1+a2 between the molar ratio 1+a1 of Li in the surface section and the molar ratio 1+a2 of Li in the central section satisfies 0.5<1+a1/1+a2<1,
Li₁₊ₐ(Mn_{b}Co_{c}Ni_{1-b-c})₁₋ₐM_{d}O₂₋ₑ (1)
where M is one or more of Al, Mg, Zr, Ti, Ba, B, Si, and Fe; and a to e satisfy 0<a<0.25, 0.5≦b<0.7, 0≦c<1−b, 0≦d≦1, and 0≦e≦1.

13. An electric power tool comprising:
a secondary battery; and
a movable section configured to be supplied with electric power from the secondary battery, wherein
the secondary battery includes a cathode, an anode, and an electrolytic solution,
the cathode includes a lithium-containing compound, the lithium-containing compound having an average composition represented by a following Formula (1),
the lithium-containing compound includes a central section and a surface section,
a molar ratio b1 of Mn in the surface section is larger than a molar ratio b2 of Mn in the central section,
a molar ratio 1+a1 of Li in the surface section is smaller than a molar ratio 1+a2 of Li in the central section, and
a ratio 1+a1/1+a2 between the molar ratio 1+a1 of Li in the surface section and the molar ratio 1+a2 of Li in the central section satisfies 0.5<1+a1/1+a2<1,
Li₁₊ₐ(Mn_{b}Co_{c}Ni_{1-b-c})₁₋ₐM_{d}O₂₋ₑ (1)
where M is one or more of Al, Mg, Zr, Ti, Ba, B, Si, and Fe; and a to e satisfy 0<a<0.25, 0.5≦b<0.7, 0≦c<1−b, 0≦d≦1, and 0≦e≦1.

14. An electronic apparatus comprising a secondary battery as an electric power supply source, wherein
the secondary battery includes a cathode, an anode, and an electrolytic solution,
the cathode includes a lithium-containing compound, the lithium-containing compound having an average composition represented by a following Formula (1),
the lithium-containing compound includes a central section and a surface section,
a molar ratio b1 of Mn in the surface section is larger than a molar ratio b2 of Mn in the central section,
a molar ratio 1+a1 of Li in the surface section is smaller than a molar ratio 1+a2 of Li in the central section, and
a ratio 1+a1/1+a2 between the molar ratio 1+a1 of Li in the surface section and the molar ratio 1+a2 of Li in the central section satisfies 0.5<1+a1/1+a2<1,
Li₁₊ₐ(Mn_{b}Co_{c}Ni_{1-b-c})₁₋ₐM_{d}O₂₋ₑ (1)
where M is one or more of Al, Mg, Zr, Ti, Ba, B, Si, and Fe; and a to e satisfy 0<a<0.25, 0.5≦b<0.7, 0≦c<1−b, 0≦d≦1, and 0≦e≦1.
